(19) United States
(12) Patent Application Publication
(10) Pub. No.: US 2024/0331517 A1
(43) Pub. Date: Oct. 3, 2024

(54) A DEVICE FOR MONITORING AN ENVIRONMENT

(71) Applicant: Essence Security International (E.S.I.) Ltd., Herzlia Pituach (IL)

(72) Inventors: Ohad AMIR, Herzliya (IL); Haim AMIR, Ramat Hasharon (IL); Jonathan Mark SCHNAPP, Tel Aviv (IL)

(21) Appl. No.: 18/259,937

(22) PCT Filed: Dec. 23, 2021
(86) PCT No.: PCT/IL2021/051532

§ 371 Date: Jun. 29, 2023

(30) Foreign Application Priority Data
Dec. 30, 2020 (IL) 279885

(51) Int. Cl. G08B 15/00; G06V 20/40; G08B 13/00

(52) U.S. Cl. CPC G08B 15/00; G06V 20/44; G08B 13/00

(57) ABSTRACT

A device for monitoring an environment is disclosed. The device comprises a processor configured to: receive input from one or more sensors, which together are associated with a plurality of locations in the environment; based on the input: detect an object at a first time, and output a first instruction for outputting a first deterrent; and determine whether a predetermined condition is met with respect to one or more of: a location of the object at a later time or a direction of travel of the object at a later time; and if the predetermined condition is met, output a second instruction to another device, the second instruction being associated with a process for outputting a second deterrent.

### RELATED APPLICATION/S

This application claims the benefit of priority of Israel Patent Application No. 279885 filed on 30 Dec. 2020, the contents of which are incorporated herein by reference in their entirety.

### BACKGROUND

Motion sensors are designed to monitor a defined area, which may be outdoors (e.g., entrance to a building, a yard, and the like), and/or indoors (e.g., within a room, in proximity of a door or window, and the like). Motion sensors may be used for security purposes, to detect intruders based on motion in areas in which no motion is expected, for example, an entrance to a home at night.

Some security systems employ a motion sensor in the form of a passive infrared (PIR) detector to sense the presence of a heat-radiating body (i.e., such a heat-radiating body would typically indicate the presence of an unauthorized person) in its field of view, and then issue a deterrent such as an audible alarm sound or flashing light. However, such deterrents may only be effective if an intruder believes that he/she is likely to be caught before the intruder completes their mission and escapes from the scene of the crime.

Reference to any prior art in this specification is not an acknowledgement or suggestion that this prior art forms part of the common general knowledge in any jurisdiction, or globally, or that this prior art could reasonably be expected to be understood, regarded as relevant/or combined with other pieces of prior art by a person skilled in the art.

### SUMMARY

One or more aspects of the present invention relate to security systems configured to output different deterrents that may escalate in severity depending on various factors. In some cases, a deterrent may be selected based on whether an intruder appears to be moving deeper into a monitored area. In other cases, the severity of the deterrent is determined based on a contextual factor such as whether a resident is at home. One or more other aspects of the invention relate to enabling an output of a deterrent, for example, by priming an output device so there is little delay when the output is triggered.

In accordance with a first aspect of the invention there is provided a device for monitoring an environment, the device comprising:
a processor configured to:
   receive input from one or more sensors, which together are associated with a plurality of locations in the environment;
   based on the input:
      detect an object at a first time; and output a first instruction for outputting a first deterrent; and
      determine whether a predetermined condition is met with respect to one or more of: a location of the object a later time or a direction of travel of the object at a later time; and
   if the predetermined condition is met, output a second instruction to another device, the second instruction being associated with a process for outputting a second deterrent.

Embodiments of the first aspect of the invention may therefore relate to monitoring progress of a threat (i.e. intruder) and providing two, possibly different and potentially escalating, deterrents dependent on the progress or lack thereof. Thus a second deterrent can be issued, which is more severe than the first deterrent, if it is determined that a risk of significant damage is increasing or is not diminishing.

For example, the first deterrent may be light or sound (e.g. a siren) and the second deterrent may comprise an intervention, for example, using one or more of: tear gas, visible-light obscuring matter (e.g. smoke, fog and/or other light particles to be suspended in air), fluid, paralyzing substance, pepper spray, sneeze inducing spray, a high output sound pressure (e.g. a sound louder than provided by the first deterrent), an electrically conductive projectile, a stink bomb, intermittent light, a physical deterrent, a physiologically affecting deterrent, a psychologically affecting deterrent, a cognitive affecting deterrent and a sense affecting deterrent other than a visual or an auditory sense affecting deterrent. In some embodiments, the deterrents may progress from one of the items in the above list to another, and, in some embodiments, the intervention may not be preceded by light or sound.

Thus, the deterrents may increase (or decrease) in a predefined sequence depending on the location or the direction of travel of the object. The sequence may comprise recommendations that require approval by a remote operator before implementing. Thus, the sequence may not be factory set and may be determined in use by the operator.

In some embodiments, the location or direction of travel of the object may be determined by a single sensor, e.g. one radar device. In which case, the location may be identified by a co-ordinate or set of co-ordinates defining an area of interest within the sensor's field of view. However, aspects of the invention also cover the case of identifying progress using a distributed set of sensors (though the set may include a radar and the functionality it enables). For example, there may be motion sensors in a house that can be used to determine how active an intruder is and/or what spaces they are moving to. For example, a living room might constitute a location that only calls for a low level deterrent but if the intruder moves toward a bedroom location then a higher level deterrent can be implemented; and if the intruder moves quickly toward the bedroom, then perhaps an even higher level of deterrent may be output.

The processor may be configured to receive input from a plurality of sensors distributed in the environment and wherein each sensor is associated with a respective location. For example, one sensor may be associated with a garden by monitoring activity within that space, another sensor may be associated with a door or window to monitor the status of an access point and other sensors may be associated with respective rooms or areas within a house such as a living room, kitchen, hallway, bedroom 1, bedroom 2 etc. In other words, the association of a sensor to a particular location in an environment may be based on the sensor's field of view or configured sensing location (e.g. in the case of a door sensor). In some embodiments, different sensors will be used to monitor different locations. However, it is possible that a single sensor may be configured to monitor two or more locations (e.g. in the case of an active reflected wave detector, which is configured to emit a signal into the environment and to detect the signal after it has been reflected from an object in the environment, and which may be configured to distinguish between objects detected in a first region and a second region within an overall field of view). In contexts where positioning is required the active reflected wave detector needs to have ranging capabilities, but in contexts where only motion needs to be detected, an active reflected wave detector need only have Doppler capabilities. For motion detection, such a Doppler detector could be used instead of a passive infrared (PIR) sensor. Optionally, the active reflected wave detector may have both ranging and Doppler capabilities, in which case the active reflected wave detector may optionally be selected to use one or more of those capabilities in a given mode of operation. Generally, the ranging capabilities consume more power than the Doppler capabilities, so may optionally not be used if and when not needed. In some embodiments, a passive infrared (PIR) sensor or Doppler (e.g. microwave Doppler) active reflected wave detector may be employed, which may only be configured to detect motion within its field of view, and not to identify different locations of an object within the field of view. Accordingly, in some embodiments a single sensor (e.g. PIR sensor) may be associated with a single location in an environment and may be configured to sense an object at that location. In some embodiments, a single sensor (e.g. a ranging device, such as may be provided by a radar for example) may be provided at a certain point in an environment but may be configured to sense an object in multiple possible locations (e.g. areas) within the sensor's field of view.

Depending on the progress, or lack of progress, of the intruder, the same one (or more) sensors may sense the object at the first time and the later time. For example, the same motion sensor may sense the person at the first time and at the later time if the person has not left the field of view of the motion sensor by the later time.

Notably, a sensor may or may not sense the object (i.e. person) directly but may instead sense a change in a sensed signal caused by an event and said event may be indicative of a presence of the object (e.g. a door sensor may simply sense opening and thereby the location of the object may be inferred).

The processor may be configured to receive input from two or more sensors that are co-located but have different fields of view. The fields of view may or may not overlap.

The input may comprise one or more signals from each sensor. For example, a sensor may only send a signal to the processor when an object (e.g. person) or event (e.g. door opening) is sensed. In other cases, a sensor may send a signal to the processor regardless of whether or not an object or event has been sensed and the processor may determine if an object has been sensed. The input may comprise one or more of: a continuous signal, a periodic signal; or a discrete signal.

The predetermined condition may simply be that a flag is set in a message received from a sensor (e.g. the sensor detected that the motion was sensed, and the message tells the processor that motion, e.g. of an object, was detected).

The location of the object may be a point, line, area, region, doorway, window or room in the environment being monitored. In some embodiments, the location may be anywhere within any region monitored by the sensor that has sensed the object. In some embodiments, the location may be within any region monitored by the sensor that has sensed the object, and which is not monitored by one or more other sensors.

The first instruction may be output, for example, to a control panel, server, monitoring station, user device or output device. The first instruction may comprise a message requesting output of the first deterrent. The first instruction may comprise a signal (which may be analogue or digital, i.e. a 1 or 0). The signal may comprise a component for triggering the outputting of the first deterrent or for initiating a process for outputting the first deterrent.

The second instruction may be output, for example, to a control panel, server, monitoring station, user device or output device. The second instruction may comprise a message requesting output of the second deterrent. The second instruction may comprise a signal (which may be analogue or digital, i.e. a 1 or 0). The signal may comprise a component for triggering the outputting of the second deterrent or for initiating a process for outputting the second deterrent.

The processor may be further configured to identify one or more of: a location or a direction of travel of the object at the first time.

The device may not know whether the object detected at the first time is the same object as that detected at the later time. However, it may be assumed that the objects are the same, particularly, if they are detected in relatively close succession. The later time may be required to be at least minimum delay after the first time; and/or no more than a maximum delay after the first time.

The processor may be configured to determine whether the predetermined condition is met with respect to one or more of: the location or the direction of travel of the object at the later time in light of the detection at the first time.

For example, the processor may be configured to determine whether the predetermined condition is met with respect to one or more of: the location or the direction of travel of the object at the later time in light of one or more of: a location or a direction of travel at the first time. For example, if an intruder is identified at a position X at the first time and having a direction Y at the later time (or vice versa), the predetermined condition may be met and further action taken. In some embodiments, the processor may be configured to determine whether the predetermined condition is met with respect to one or more of: the location or the direction of travel of the object at the later time compared with the object at the first time. For example, if an intruder is identified at a position X at the first time and position Y at the later time (or direction X at the first time and direction Y at the later time), the predetermined condition may be met and further action taken. In another example, the predetermined condition may test the direction of travel at the later time, based on an object having been detected at the first time; or based on a detected position of an object at the first time. An object moving in one or more ranges of directions at the later time may result in passing or failing in relation to the predetermined condition. In yet another example, the predetermined condition may test the position of travel at the later time, based on an object having been detected at the first time; or based on a detected direction of an object at the first time. An object being in one or more defined regions at the later time may result in passing or failing in relation to the predetermined condition.

The predetermined condition may comprise at least one of: a lack of change in location; or a lack of change in direction of travel.

The direction of travel at the later time may be determined from an identified location of the object at an initial time and the location of the object at the later time.

The initial time may be the same as the first time.

The initial time may be closer to the later time than the first time. This may help to give a better indication of the direction of travel at, or substantially around, the later time.

The direction of travel at the later time may be determined based on the respective locations associated with at least two motion sensors that respectively detect an object at the initial time and the later time.

The later time need not be fixed with respect to the first time. In some embodiments, the later time is determined by an event. For example, if a sensor that did not recently detect the object begins to detect the object, the later detection may define the later time.

One or more of: the location or the direction of travel of the object may be determined using an active reflected wave sensor (e.g. which is configured to emit a signal into the environment and to detect the signal after it has been reflected from an object in the environment). The detection of the object at the first time may or may not be based on the active reflected wave reflector. For example, a motion sensor may detect the object at the first time and an active reflected wave sensor may determine the location or the direction of travel of the object at the later time. Optionally, the motion sensor and the active reflected wave sensor may have different fields of view.

A given location of the object may be a region defined by a virtual fence within a region that is detectable by the active reflected wave detector. In other words, the location may be a defined region of interest within a field of view of the active reflected wave detector.

The processor may be configured to identify one or more of: the location or the direction of travel of the object at the later time, only after a predefined delay after one of: detection of the object at the first time; output of the first instruction for outputting the first deterrent; or when the first deterrent is actually output. For example, there may be a minimum amount of time that must pass between detection of the object at the first time and consideration of the location or the direction of travel of the object at the later time.

The processor may be configured to identify one or more of: the location or the direction of travel of the object at the later time, only after receipt of a confirmation that the outputting of the first deterrent has occurred.

In at least one embodiment, the later time is within a predefined maximum time period from one of: the first time; the outputting of the instruction for outputting the first deterrent; or the outputting of the first deterrent.

The pre-determined condition may comprise at least identification of one or more of: a location or a direction of travel of the object at the later time; and, if the location or direction of travel of the object cannot be identified at the later time (e.g. within the maximum time period defined above), the processor may reset and begin looking for an object at a new first time.

If there is no identification of one or more of: a location or a direction of travel of an object within a predefined time window, the processor may be configured to output an instruction to cease output of the first deterrent.

If, after the output an instruction for outputting a first deterrent, the processor receives input indicating that the object has left the environment, the processor may be configured to output an instruction to cease output of the first deterrent.

The input indicating that the object has left the environment may comprise data from an exit point of the environment.

The predetermined condition may comprise that the location of the object is in a predetermined area at the later time.

The predetermined condition may comprise that the direction of travel of the object at the later time is in a predetermined direction.

The predetermined condition may comprise that the object is not leaving the environment.

The predetermined condition may be further based on a determined speed of travel of the object at the later time. In some embodiments, the predetermined condition may be based on a velocity (including speed and direction) of the object at the later time.

The predetermined condition may comprise that the object has moved towards a predetermined area or a designated location within the environment.

The input from each sensor may be identifiable as being from one or more of:
a particular one of the sensors; or
a particular location.

The input from each sensor may be identifiable by one or more of:
an identifier;
the input from each sensor having a characteristic signal type;
the input from each sensor being received in a pre-defined time window;
the input from each sensor being received at a pre-defined frequency.

The identifier may comprise a unique number or string of characters to identify each sensor and/or its location.

The characteristic signal type may be based on one or more of: an analogue signal; a digital signal; a pre-defined strength; a pre-defined duration or a pre-defined frequency.

In some embodiments, the input from each sensor may be received in a pre-defined time window such that, for example, if there are 4 distinct inputs from 4 distinct sensors, each input may be allocated one of 4 unique time slots within a total combined listening period. Consequently, any inputs may be determined to have been received within one of the 4 possible time slots and the identification of a particular time slot related to a corresponding sensor using, for example, a memory or look-up table.

Similarly, in some embodiments, the input from each sensor may be received at a pre-defined frequency such that, for example, if there are 2 distinct inputs from 2 distinct sensors, each input may be received at one of 2 unique frequencies. Identification of the frequency of a particular input may therefore be related to a corresponding sensor as stored, for example, in a memory or look-up table.

The process for outputting the second deterrent may comprise at least one of: prompting a user for confirmation to begin outputting the second deterrent; enabling outputting of the second deterrent; or triggering outputting of the second deterrent.

The process for outputting the second deterrent may comprise an option to abort the process. The option to abort may be presented to a user (e.g. a human operator).

The instruction for outputting the first deterrent may comprise instructing at least one light source to emit light as at least part of the first deterrent.

The instruction for outputting the first deterrent may comprise instructing a control of one or more of the at least one light source to emit a beam of light to selectively illuminate an identified location of the object at the first time.

The instruction for outputting the first deterrent may comprise instructing at least one speaker to emit audio as at least part of the first deterrent.

The audio may comprise an alarm sound.

The audio may comprise an audible speech message.

The first deterrent may comprise one of or any combination of: tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent.

The second deterrent may comprise one of or any combination of: light, audio, tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent.

The first deterrent could be a single deterrent (e.g. an alarm) or a combination of individual deterrents (e.g. light and sound).

The second deterrent may comprise one or more deterrents that the first deterrent does not comprise. The first deterrent may continue while the second deterrent is output.

The second deterrent may comprise a deterrent other than a light or an audio deterrent.

The second deterrent may comprise one or more deterrents classified as having an increased deterrent effect when compared to the first deterrent.

The second deterrent may have an effect on at least one of: (i) a physiological functioning (e.g. by impairing an ability of an intruder, or irritating them at a physiological level); (ii) a cognitive functioning; or (iii) one or more sense other than visual or auditory senses (e.g. balance, proprioception, smell, taste, touch, orientation).

The second deterrent may induce a reaction in a person to physically impair and/or psychologically hinder their ability to proceed with an intended task and/or make doing so uncomfortable, difficult or even painful. The second deterrent may have an effect of reducing a person's well-being and/or ability to think, act or move. In some cases, the second deterrent may take the form of a physical obstacle, which must be overcome, in order for the person to proceed in the environment.

The second deterrent could be a single deterrent (e.g. visible-light obscuring matter) or a combination of individual deterrents (e.g. sound and visible-light obscuring matter).

If the predetermined condition is met, the processor may be configured to control a camera to capture at least one image of said environment.

The device may further comprise selecting a type of deterrent based on at least one contextual factor such that the second deterrent is based on said type.

The one or more sensors may comprise one or more: motion sensor, thermal sensor, magnetic sensor, proximity sensor, threshold sensor, passive infrared sensor, active reflected wave sensor, door sensor, or window sensor.

The active reflected wave sensor may be constituted by a radar device.

The device may be configured as a control hub for a security system. In which case the device may receive input from a sensor such as a motion sensor configured to detect an object. The input may comprise a message or signal indicating that the sensor has detected an object (e.g. a person) and the control hub may initiate the process for outputting the second deterrent, even if that process requires a user confirmation thereafter.

The device may comprise a housing holding one from or any combination from a group consisting of: any one or more of the plurality of sensors; any one or more output devices for outputting the first deterrent; any one or more output devices for outputting the second deterrent; and a camera. For example, the device could form part of: a sensor; an output device; a camera or any combination of these elements.

In some embodiments, the device may serve as a common processor in a common housing with an output device for the first deterrent and an output device for the second deterrent.

In accordance with a second aspect of the invention there is provided a computer implemented method for monitoring an environment, the method comprising:
receiving input from one or more sensors, which together are associated with a plurality of locations in the environment;
based on the input:
   detecting an object at a first time; and outputting a first instruction for outputting a first deterrent; and
   determining whether a predetermined condition is met with respect to one or more of: a location of the object at a later time or a direction of travel of the object at a later time; and
   if the predetermined condition is met, outputting a second instruction to another device, the second instruction being associated with a process for outputting a second deterrent.

In accordance with a third aspect of the invention there is provided a non-transitory computer-readable storage medium comprising instructions which, when executed by a processor cause the processor to perform a method of:
receiving input from one or more sensors, which together are associated with a plurality of locations in the environment;
based on the input:
   detecting an object at a first time; and outputting a first instruction for outputting a first deterrent; and
   determining whether a predetermined condition is met with respect to one or more of: a location of the object at a later time or a direction of travel of the object at a later time; and
   if the predetermined condition is met, outputting a second instruction to another device, the second instruction being associated with a process for outputting a second deterrent.

In accordance with a fourth aspect of the invention there is provided a system for monitoring an environment, the system comprising:
one or more sensors, which together are associated with a plurality of locations in the environment;
at least one output device; and
at least one processor, wherein the at least one processor is configured to perform steps of:
receive input from the one or more sensors;
based on the input:
   detect an object at a first time; and output a first instruction to the at least one output device for outputting a first deterrent; and
   determine whether a predetermined condition is met with respect to one or more of: a location of the object at a later time or a direction of travel of the object at a later time; and
   if the predetermined condition is met, output a second instruction to another device, the second instruction being associated with a process for outputting a second deterrent.

The another device may be a remote device.

The second instruction may be output to the remote device by a wireless communication via a telecommunications network. For example, the system may comprise a modem configured for cellular communication of the second instruction.

The another device may be a monitoring station.

One or more of the steps of the at least one processor may be performed by a processor in a control hub.

One or more of the steps of the at least one processor may be performed by a processor in one or more of the plurality of sensors.

One or more of the steps of the at least one processor may be performed by a processor in one or more of the at least one output device.

One or more of the steps of the at least one processor may be performed by a processor in a monitoring station.

If the predetermined condition is met, the at least one processor may be configured to: control a camera to capture at least one image of said environment;
instruct a monitoring station to display said at least one image; and
after said display, receive a user input from the monitoring station confirming the output of said second deterrent and control the at least one output device to output said second deterrent in response to the user input.

In some embodiments, the system may comprise a monitoring station; and wherein if the predetermined condition is met, the at least one processor is configured to:
control a camera to capture at least one image of said environment;
display said at least one image on a display of the monitoring station; and

after said display, receive a user input at the monitoring station confirming the output of said second deterrent and control the at least one output device to output said second deterrent in response to the user input.

The camera may be configured to capture multiple images, for example, in the form of a video.

The process for outputting the second deterrent may comprise prompting a user for confirmation to begin outputting the second deterrent, wherein the prompting may take place after said display.

The first deterrent and the second deterrent may be output from separate ones of the at least one output device.

In some embodiments, the first deterrent and the second deterrent may be output from a same one of the at least one output device.

In accordance with another aspect of the invention there is provided a device for monitoring an environment, the device comprising:

a processor configured to:
receive input from one or more sensors, which together are associated with respective locations in the environment;
based on the input:
   detect an object at a first time; and output a first instruction for outputting a first deterrent; and
   determine whether a predetermined condition is met with respect to one or more of: a location of the object at a later time or a direction of travel of the object at a later time; and
if the predetermined condition is met, output a second instruction associated with a process for outputting a second deterrent, wherein the second deterrent comprises one or more of: tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, a psychologically affecting deterrent, a cognitive affecting deterrent and a sense affecting deterrent other than a visual or an auditory sense affecting deterrent.

In accordance with a fifth aspect of the invention there is provided a device for determining a type of deterrent to output by a security system in response to detection of an object in an environment, the device comprising:
a processor configured to:
   receive input from at least one sensor arranged to sense an object in the environment;
   process the input to detect the object in the environment;
   in response to detection of said object at a first time, output a first instruction for outputting a first deterrent;
   determine whether a predetermined condition with respect to the object is met at a later time; and
   if the predetermined condition is met, select a type of deterrent based on at least one contextual factor, and output a second instruction associated with a process for outputting a second deterrent based on said type.

Embodiments of the fifth aspect of the invention may therefore relate to a device configured to select a type of deterrent (which may be a specific deterrent) to be output depending on a risk level associated with a contextual factor. The contextual factor may relate to, for example: a type of premises (e.g. what is at risk and how quickly is it at risk); how dangerous is the deterrent (e.g. likelihood of causing injury); is the premises occupied (e.g. is a person in danger by the intruder and/or will the resident be affected by the deterrent); an urgency of deterring a detected person (e.g. threat to human life or a need to act quickly due to a value of goods and time with which they may be stolen); and a consequence of using the deterrent (e.g. time or cost for replenishment of deterrent). By way of illustration, the deterrent may escalate from an audio warning, to visible-light obscuring matter, to electrify, then sneezing powder etc. if the context dictates that the risk is increasing.

The instruction may be output to another device associated with the process for outputting the second deterrent based on said type.

The type of deterrent may be associated with a list of available deterrents, from which a user further selects the second deterrent.

The type of deterrent may be associated with a subset of a list of available deterrents, from which a user further selects the second deterrent.

The intention is to cover automatic selection of, say, a type A deterrent based on a contextual factor, wherein there may be a number of available deterrents classed as type A/B/C etc. . . . Note, all available deterrents may be in class A. In which case, class A may include sub-classes.

The type of deterrent may be associated with a specific deterrent.

The type of deterrent may be associated with a specific combination of deterrents for outputting.

The type of deterrent may be associated with one or more deterrents from a list comprising: light, audio, tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent.

The at least one contextual factor may comprise information about the whereabouts of one or more persons associated with the environment. The persons associated with the environment may be residents or workers expected to spend time in the environment and not the object detected by the device, which may be an intruder.

The information about the whereabouts may be inferred from data obtained from the at least one sensor.

The information about the whereabouts may comprise whether one or more persons are in the environment.

The at least one contextual factor may comprise information obtained from a look-up table.

The information obtained from the look-up table may comprise information on a type of the environment.

The type of the environment may comprise one or more of commercial, residential, valuable goods store, jewellery store, or bank.

The at least one contextual factor may comprise time-based information.

The time-based information may comprise whether the later time is at night-time.

The time-based information may comprise whether the later time is during a time window associated with a normal operational practice in the environment.

The predetermined condition may be determined with respect to one or more of: a location or a direction of travel of the object at the later time.

The predetermined condition may be determined based on a speed of the object.

The speed of the object may be determined by how soon after a known event the object is detected at a specified location.

The speed of the object may be determined using an active reflected wave sensor.

The process for outputting the second deterrent may comprise at least one of: prompting a user for confirmation to begin outputting the second deterrent; enabling outputting of the second deterrent; or triggering outputting of the second deterrent.

The process for outputting the second deterrent may comprise an option to abort the process.

The selection of the type of deterrent may be based on one or more of: an economic consideration; a risk of injury; a risk of damage; a risk of affecting a person other than an intruder; a level of urgency; or a consideration of how targeted the outputting of the deterrent is.

The contextual factor may be based on whether the security system is set to fully armed or partially armed.

The contextual factor may comprise one or more of:
a) a measured behavioral response to an already outputted deterrent;
b) whether a weapon is detected;
c) a measured physiological parameter;
d) a measured speed of approach of the object to a potential occupant; or
e) a gait of a detected person.

The contextual factor may comprise an identity of the object (e.g. intruder).

In accordance with a sixth aspect of the invention there is provided a computer implemented method for determining a type of deterrent to output by a security system in response to detection of an object in an environment, the method comprising:
receiving input from at least one sensor arranged to sense an object in the environment;
processing the input to detect the object in the environment;
in response to detection of said object at a first time, outputting a first instruction for outputting a first deterrent;
determining whether a predetermined condition with respect to the object is met at a later time; and
if the predetermined condition is met, selecting a type of deterrent based on at least one contextual factor, and outputting a second instruction associated with a process for outputting a second deterrent based on said type.

In accordance with a seventh aspect of the invention there is provided a non-transitory computer-readable storage medium comprising instructions which, when executed by a processor cause the processor to perform a method of:
receiving input from at least one sensor arranged to sense an object in the environment;
processing the input to detect the object in the environment;
   in response to detection of said object at a first time, outputting a first instruction for outputting a first deterrent;
   determining whether a predetermined condition with respect to the object is met at a later time; and
   if the predetermined condition is met, selecting a type of deterrent based on at least one contextual factor, and outputting a second instruction associated with a process for outputting a second deterrent based on said type.

In accordance with an eighth aspect of the invention there is provided a system for determining a type of deterrent to output by a security system in response to detection of an object in an environment, the system comprising:
at least one sensor arranged to sense an object in the environment;
at least one output device; and
at least one processor, wherein the at least one processor is configured to perform steps of:
   receiving input from at least one sensor arranged to sense an object in the environment;
   processing the input to detect the object in the environment;
   in response to detection of said object at a first time, outputting a first instruction for outputting a first deterrent;
   determining whether a predetermined condition with respect to the object is met at a later time; and
   if the predetermined condition is met, selecting a type of deterrent based on at least one contextual factor, and outputting a second instruction associated with a process for outputting a second deterrent based on said type.

One or more of the steps of the at least one processor may be performed by a processor in a control hub.

One or more of the steps of the at least one processor may be performed by a processor in one or more of the at least one sensor.

One or more of the steps of the at least one processor may be performed by a processor in one or more of the at least one output device.

One or more of the steps of the at least one processor may be performed by a processor in a monitoring station.

If the predetermined condition is met, the at least one processor may be configured to: control a camera to capture at least one image of said environment;
instruct a monitoring station to display said at least one image; and after said display, receive a user input from the monitoring station confirming the output of said second deterrent and control the at least one output device to output said second deterrent in response to the user input.

The system may further comprise a monitoring station; and if the predetermined condition is met, the at least one processor may be configured to:
control a camera to capture at least one image of said environment;
display said at least one image on a display of the monitoring station; and
after said display, receive a user input at the monitoring station confirming the output of said second deterrent and control the at least one output device to output said second deterrent in response to the user input.

The first deterrent and the second deterrent may be output from separate ones of the at least one output device.

The first deterrent and the second deterrent may be output from a same one of the at least one output device.

In accordance with a ninth aspect of the invention there is provided a device for enabling output of a deterrent by a security system in response to detection of an object in an environment, the device comprising:
a processor configured to:
   receive input from at least one sensor arranged to sense an object in the environment;
   process the input to detect the object in the environment; and
   if at least one of:
      the object is detected; or
      a condition associated with the object is met;
   output an instruction associated with a process for outputting a deterrent;
   wherein the instruction comprises a request to enable output of the deterrent,
   wherein output of the deterrent requires at least that output of the deterrent is enabled and that output of the deterrent is triggered.

Embodiments of the ninth aspect of the invention may therefore relate to a device for enabling output of a deterrent such that there is little delay from when a deterrent is triggered to when the deterrent is output.

The instruction may be output to another device associated with the process for output of the deterrent.

The request to enable output of the deterrent may comprise requesting a priming of an output device for outputting the deterrent.

The request to enable output of the deterrent may comprise requesting a check that an output device is configured for outputting the deterrent.

The request to enable output of the deterrent may comprise requesting a safety procedure prior to outputting of the deterrent.

The request to enable output of the deterrent may comprise controlling an electrical circuit that is independent of an electrical circuit used to trigger the deterrent.

The request to enable output of the deterrent may comprise instructing a switch to be set to permit triggering of the deterrent.

The process for outputting the deterrent may comprise prompting a user for confirmation to begin outputting the deterrent.

The request to enable output of the deterrent may be output at a time prior to the prompting of the user for confirmation. This may be advantageous to ensure that the output of the deterrent is enabled before the outputting is triggered. Confirmation of enablement may be provided to the user when prompting for confirmation to [proceed with the outputting. Thus, on receipt of the user confirmation to proceed, the system is already enabled and there is little delay before the outputting of the deterrent. In other words, the user can be confident that after they enter their confirmation, the outputting will proceed without further delay. In some embodiments, the user may be presented with an indicator (e.g. in the form of a message or green light) indicating that the system is enabled and ready to output the deterrent if they wish to proceed.

The request to enable output of the deterrent may be output at substantially a same time as the prompting of the user for confirmation.

The request to enable output of the deterrent may be transmitted to a first device and the process may comprise transmitting a request to a second device to initiate a procedure for implementing the triggering of the deterrent, the second device being remote from the first device.

The device may comprise a housing in which one of: the first device and the second device is provided.

The procedure for implementing the triggering of the deterrent may comprise prompting, via a user device, a user for confirmation to begin outputting the deterrent; awaiting a user response from the user device; and, if the user response is to proceed, transmitting a trigger to output the deterrent.

The procedure may further comprise issuing a challenge to the user device; verifying a challenge response from the user device; and only transmitting the trigger to output the deterrent if the user response is to proceed and the challenge response is verified.

The challenge may be unique and may be based on one or more of: a time-stamp;
counter; and random number.

The process for outputting the deterrent may comprise an option to abort the process.

The process for outputting the deterrent may comprise triggering output of the deterrent only within a predefined time window after an event.

The event may comprise one or more of: the deterrent is enabled; the object is detected; the condition is met; or the output of the instruction.

The event may comprise the prompting of the user for confirmation to begin outputting the deterrent.

The process for outputting the deterrent may comprise triggering output of the deterrent after receipt of user confirmation to proceed.

The condition may be determined with respect to one or more of: a location; a direction of travel or a speed of travel f the object.

The processor may be further configured to select a type of deterrent based on at least one contextual factor such that the deterrent is based on said type.

In accordance with a tenth aspect of the invention there is provided a computer implemented method for enabling output of a deterrent by a security system in response to detection of an object in an environment, the method comprising:
receiving input from at least one sensor arranged to sense an object in the environment;
processing the input to detect the object in the environment; and
   if at least one of:
      the object is detected; or
      a condition associated with the object is met;
   output an instruction associated with a process for outputting a deterrent;
   wherein the instruction comprises a request to enable output of the deterrent, and wherein output of the deterrent requires at least that output of the deterrent is enabled and that output of the deterrent is triggered.

In accordance with an eleventh aspect of the invention there is provided a non-transitory computer-readable storage medium comprising instructions which, when executed by a processor cause the processor to perform a method of:
receiving input from at least one sensor arranged to sense an object in the environment;
processing the input to detect the object in the environment; and
if at least one of:
   the object is detected; or
   a condition associated with the object is met;
   output an instruction associated with a process for outputting a deterrent;
   wherein the instruction comprises a request to enable output of the deterrent, and
wherein output of the deterrent requires at least that output of the deterrent is enabled and that output of the deterrent is triggered.

In accordance with a twelfth aspect of the invention there is provided a system for enabling output of a deterrent by a security system in response to detection of an object in an environment, the system comprising:
at least one sensor arranged to sense an object in the environment;
at least one output device; and
at least one processor, wherein the at least one processor is configured to perform steps of:
   receiving input from the at least one sensor;
   processing the input to detect the object in the environment; and
   if at least one of:
      the object is detected; or
      a condition associated with the object is met;
      outputting an instruction associated with a process for outputting a deterrent;
      wherein the instruction comprises a request to enable output of the deterrent, and wherein output of the deterrent requires at least that output of the deterrent is enabled and that output of the deterrent is triggered.

One or more of the steps of the at least one processor may be performed by a processor in a control hub.

One or more of the steps of the at least one processor may be performed by a processor in one or more of the at least one sensor.

One or more of the steps of the at least one processor may be performed by a processor in one or more of the at least one output device.

One or more of the steps of the at least one processor may be performed by a processor in a monitoring station.

The at least one processor may be further configured to:
control a camera to capture at least one image of said environment;
instruct a monitoring station to display said at least one image; and
after said display, receive a user input from the monitoring station confirming the output of said deterrent and control the at least one output device to output said deterrent in response to the user input.

The system may further comprise a monitoring station; and if the predetermined condition is met, the at least one processor may be configured to:
control a camera to capture at least one image of said environment;
display said at least one image on a display of the monitoring station; and
after said display, receive a user input at the monitoring station confirming the output of said second deterrent and control the at least one output device to output said second deterrent in response to the user input.

In relation to the non-transitory computer-readable storage mediums defined above, the instructions may be provided on one or more carriers. For example there may be one or more non-transient memories, e.g. a EEPROM (e.g. a flash memory) a disk, CD—or DVD-ROM, programmed memory such as read-only memory (e.g. for Firmware), one or more transient memories (e.g. RAM), and/or a data carrier(s) such as an optical or electrical signal carrier. The memory/memories may be integrated into a corresponding processing chip and/or separate to the chip. Code (and/or data) to implement embodiments of the present disclosure may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language, or any other code for executing by any one or more other processing device, e.g. such as those exemplified herein.

As will be appreciated from the description herein, each processor described above may be comprised of a plurality of processing units/devices.

These and other aspects will be apparent from the embodiments described in the following. The scope of the present disclosure is not intended to be limited by this summary nor to implementations that necessarily solve any or all of the disadvantages noted.

Any features described in relation to one aspect of the invention may be applied to any one or more other aspect of the invention.

### BRIEF DESCRIPTION OF THE SEVERAL VIEW OF THE DRAWINGS

For a better understanding of the present disclosure and to show how embodiments may be put into effect, reference is made to the accompanying drawings in which:

FIG. 1 illustrates a first system comprising two distributed sensors in an environment in which a device according to a first embodiment of the invention has been positioned;

FIG. 2 illustrates a process for monitoring an environment, as implemented by the device of FIG. 1;

FIG. 3 is a schematic block diagram of the system of FIG. 1;

FIG. 4 illustrates a second system, having co-located sensors in an environment, according to a second embodiment of the invention;

FIG. 5 illustrates predetermined areas within a field of view of the active reflected wave detector of FIG. 4;

FIG. 6 illustrates a third system employing a single active reflected wave detector in an environment, according to a third embodiment of the invention;

FIG. 7 illustrates a system comprising a device for determining a type of deterrent to output in response to detection of an object in an environment;

FIG. 8 illustrates a process for determining a type of deterrent to output, as implemented by the system of FIG. 7;

FIG. 9 is a schematic block diagram of the system of FIG. 7;

FIG. 10 illustrates a system comprising a device for enabling output of a deterrent in response to detection of an object in an environment;

FIG. 11 illustrates a process for enabling output of a deterrent, as implemented by the system of FIG. 10; and

FIG. 12 is a schematic block diagram of the system of FIG. 10.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized, and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents. In the following embodiments, like components are labelled with like reference numerals.

In the following embodiments, the term data store or memory is intended to encompass any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., EEPROM, solid state drives, random-access memory (RAM), etc.), and/or the like. As used herein, except wherein the context requires otherwise, the terms “comprises”, “includes”, “has” and grammatical variants of these terms, are not intended to be exhaustive. They are intended to allow for the possibility of further additives, components, integers or steps.

The functions or algorithms described herein are implemented in hardware, software or a combination of software and hardware in one or more embodiments. The software comprises computer executable instructions stored on computer readable carrier media such as memory or other type of storage device. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, microcontroller or other type of processing device or combination thereof.

Specific embodiments will now be described with reference to the drawings.

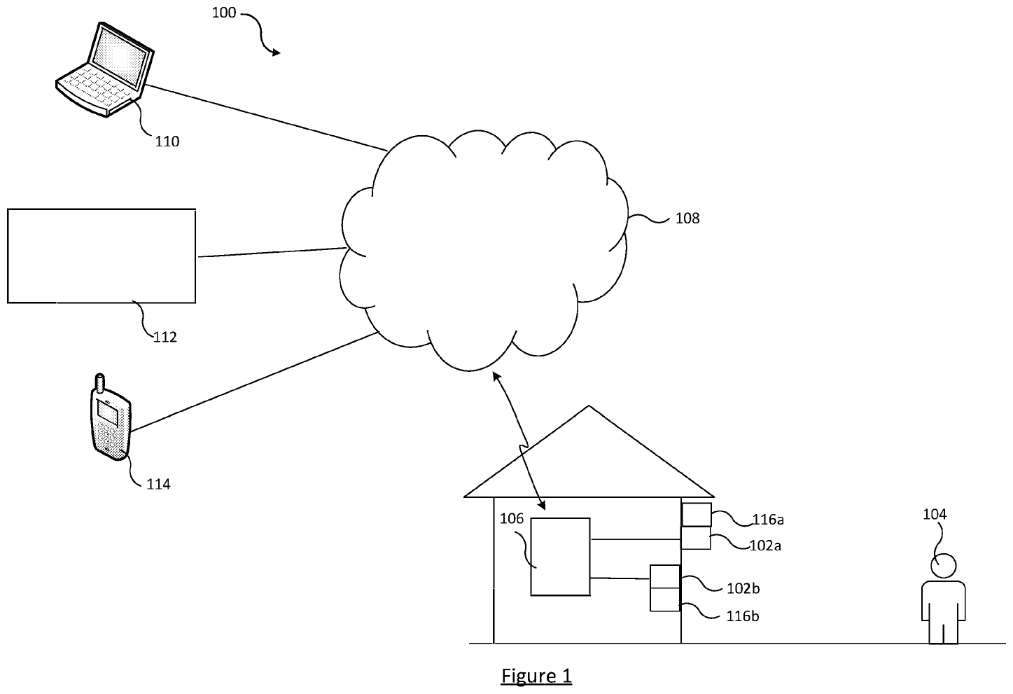

FIG. 1 illustrates a first system 100 comprising two distributed sensors 102a and 102b in an environment in which a hub device 106 according to a first embodiment of the invention has been positioned. The environment in this instance is a home and adjacent garden. However, in other embodiments the environment may be or comprise, for example, an outdoor space (e.g. car park) associated with a residential or commercial property, or a public space (e.g. park or train station). In some embodiments, the environment may be or comprise an indoor space such as inside a home (e.g. one or more rooms of the home), a shop floor, a public building or other enclosed space.

In the embodiment of FIG. 1, sensor 102a is mounted to an exterior wall of the home and is arranged to monitor an outside space in which a target object (e.g. a person 104) may be present. Similarly, sensor 102b is mounted to an interior wall of the home and is arranged to monitor an inside space in which a target object (e.g. a person 104) may be present. However, the sensors 102a and 102b together are associated with at least two locations in the environment being monitored. Note, the target object may be the same or different in each case (e.g. the same person may be detected by both sensors or different persons may be detected by each sensor, but the latter case may be rare and so the system may behave as though it were the same person).

As shown in FIG. 1, the sensors 102a and 102b are coupled to the hub device 106 by way of a wired and/or wireless connection. Preferably, the sensors 102a and 102b are coupled wirelessly to the hub device 106 which, in this embodiment, serves as a control hub, and which may be in the form of a control panel.

The hub device 106 is configured to transmit data to a remote monitoring station 110 over a network 108. An operator at the remote monitoring station 110 responds as needed to incoming notifications which may be triggered by the sensors 102a and 102b and may also respond to incoming notifications triggered by other similar devices which monitor other environments. In other embodiments, the sensors 102a and 102b may transmit data to the remote monitoring station 110 without interfacing with the hub device 106. In both examples, the data from the sensors 102a and 102b may be sent (from the sensors 102a and 102b or hub device 106) directly to the remote monitoring station 110 or via a remote server 112. The remote monitoring station 110 may comprise for example a laptop, notebook, desktop, tablet, smartphone or the like, or a plurality of such devices, which may be members of a network. Furthermore, the monitoring station may comprise a server for handling communications to and from the plurality of such devices.

Additionally or alternatively, the hub device 106 may transmit data to a remote personal computing device 114 over the network 108. A user of the remote personal computing device 114 is associated with the environment monitored by the sensors 102a and 102b—for example, the user may be the homeowner of the environment being monitored, or an employee of the business whose premises are being monitored by the sensors 102a and 102b. In other embodiments, the sensors 102a and 102b may transmit data to the remote personal computing device 114 without interfacing with the hub device 106. In both examples the data from the sensors 102a and 102b may be sent (from the sensors 102a and 102b or hub device 106) directly to the remote personal computing device 114 or via the server 112. The remote personal computing device 114 may be for example a laptop, notebook, desktop, tablet, smartphone or the like.

The network 108 may be any suitable network, which has the ability to provide a communication channel between the sensors 102a and 102b and/or the hub device 106 to the remote devices 110, 112, 114. For example, the network 108 may be a cellular communication network such as may be configured for 3G, 4G or 5G telecommunication.

In some embodiments, no hub device 106 may be present. In which case, the sensors 102a and 102b may be coupled wirelessly to the server 112 or monitoring station 110 (e.g. via a cellular communication network) and the server 112 or monitoring station 110 may perform the functions of the hub device 106 as described.

In addition, the system 100 comprises a first output device 116a and a second output device 116b. In this embodiment, the first output device 116a is collocated with the sensor 102a on the exterior wall of the home and the second output device 116b is collocated with the sensor 102b on the interior wall of the home. The output devices 116a, 116b are coupled to the hub device 106 by way of a wired and/or wireless connection. Preferably, the output devices 116a. 116b are coupled wirelessly to the hub device 106. In some embodiments, the output devices 116a, 116b and the sensors 102a, 102b share a common interface for communication with the hub device 106. In other embodiments, the output devices 116a, 116b may be located remotely from the sensors 102a, 102b. In embodiments where no hub device 106 is present, the output devices 116a, 116b may be coupled wirelessly to the server 112 or monitoring station 110 (e.g. via a cellular communication network) and the server 112 or monitoring station 110 may perform the functions of the hub device 106 as described.

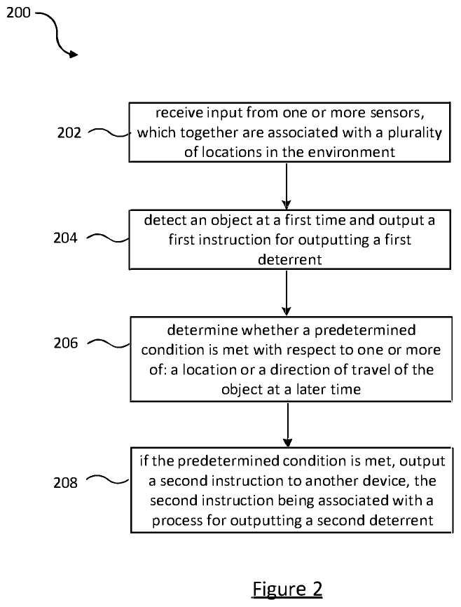

General operation of the hub device 106 is outlined in the flow diagram 200 of FIG. 2. In this case, the hub device 106 is configured for monitoring the environment and comprises a processor configured to receive input from one or more sensors 102a, 102b, which together are associated with a plurality of locations in the environment, in a step 202. Based on the input, a step 204 is performed to detect an object 104 at a first time and output a first instruction for outputting a first deterrent. Next, a step 206 is performed to determine whether a predetermined condition is met with respect to one or more of: a location or a direction of travel of the object 104 at a later time. If the predetermined condition is met, a step 208 is performed to output a second instruction to another device, the second instruction being associated with a process for outputting a second deterrent.

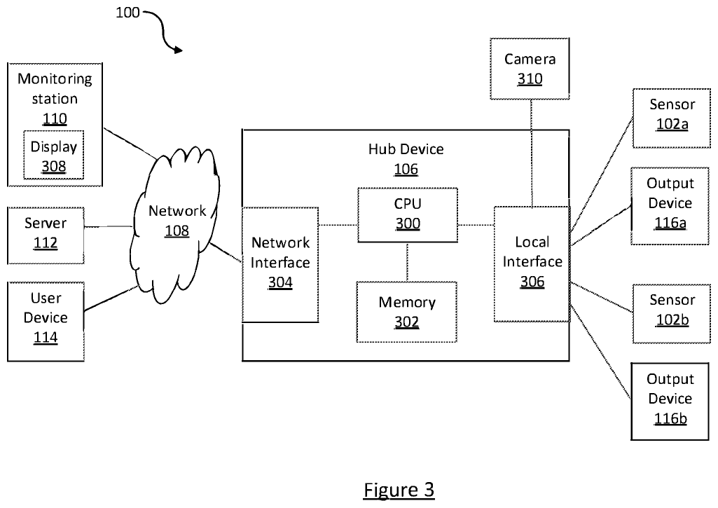

Further details of operation of the system 100 will be described below with reference to FIG. 3, which shows a schematic diagram of the system 100. The hub device 106 comprises a processor in the form of a central processing unit (CPU) 300 connected to a memory 302, a network interface 304 and a local interface 306.

The functionality of the CPU 300 described herein may be implemented in code (software) stored on a memory (e.g. memory 302) comprising one or more storage media, and arranged for execution on a processor comprising one or more processing units. That is, the hub device 106 may comprise one or more processing units for performing the processing steps described herein. The storage media may be integrated into and/or separate from the CPU 300. The code is configured to perform operations in line with embodiments discussed herein, when fetched from the memory and executed on the processor. In some embodiments, some or all of the functionality of the CPU 300 may be implemented in dedicated hardware circuitry (e.g. ASIC(s), simple circuits, gates, logic, etc.) and/or configurable hardware circuitry like an FPGA. In other embodiments (not shown) the one or more processing units that execute the processing steps described herein may be located in one or more other devices in the system 100. The processor may be comprised of distributed processing devices, which may for example comprise any one or more of the processing devices or units referred to herein. The distributed processing devices may be distributed across two or more devices shown in the system 100. Thus, some or all of the functionality of the CPU 300 may be performed in, for example, a sensor device, an output device, a monitoring station, a server, a user device or a camera.

FIG. 3 shows the CPU 300 being connected through the local interface 306 to a first sensor 102a, a second sensor 102b and a camera 310. While in the illustrated embodiment the sensor 102a, sensor 102b and camera 310 are separate from the CPU 300, in other embodiments, one or more processing aspects of the sensor 102a and/or sensor 102b and/or camera 310 may be provided by a processor that also provides the CPU 300, and resources of the processor may be shared to provide the functions of the CPU 300 and the processing aspects of the sensor 102a and/or sensor 102b and/or camera 310. Similarly, functions of the CPU 300, such as those described herein, may be performed in the sensor 102a and/or the sensor 102b and/or the camera 310.

It will be appreciated from the below that in some embodiments, the sensor 102b may not be present (i.e. only one sensor may be provided). The one sensor may be an active reflected wave detector. In embodiments where one of the sensors is a motion sensor and one of the sensors is an active reflected wave detector, the active reflected wave detector may consume more power in an activated state (i.e. when turned on and operational) than the motion sensor does when in an activated state. In some embodiments, three or more sensors may be provided, for example, one in each room of a building.

It will be appreciated from the below that in some embodiments, the camera 310 may not be present.

As also shown in FIG. 3 the CPU 300 is connected through the local interface 306 to a first output device 116a and a second output device 116b. It will be appreciated from the below that in some embodiments, the second output device 116b may not be present. In other embodiments, three or more output devices may be provided, for example, distributed around and within a building.

FIG. 3 also shows the CPU 300 being connected through the network interface 304 to the network 108, where it is then connected separately to the monitoring station 110, the remote server 112 and the remote personal computing device in the form of a user device 114. Thus, the network interface 304 may be used for communication of data to and from the hub device 106. The local interface 306 may operate using local or short-range communication protocol, for example WIFI, Bluetooth, a proprietary protocol, protocol in accordance with IEEE standard 802.15.4, or the like. The network interface 304 may operate using a cellular communication protocol such as 4G. In some embodiments, the local interface 306 and the network interface 304 may be combined in a single module and may operate using a common communication protocol. In some embodiments, the local interface 306 may not be required and instead only the network interface 304 may be required for all communications. This may be the case where the sensors 102a, b are configured to communicate directly with the CPU 300 in a remote server 112, for example, where there is no local hub device 106.

A housing may be provided around any one or more of the hub device 106, the first sensor 102a, the second sensor 102b, the first output device 116a, the second output device 116b and the camera 310. Accordingly, any of these components may be provided together or separately. Separate components may be coupled to the CPU 300 by way of a wired or wireless connection. Further, the outputs of the first sensor 102a, the second sensor 102b and/or the camera 310 may be wirelessly received from/via an intermediary device that relays, manipulates and/or in part produces their outputs.

In some embodiments, the CPU 300 is configured to detect motion in the environment based on an input received from the first sensor 102a or the second sensor 1202b. The first and second sensors 102a,b may each take the form of any of: a motion sensor (e.g. a passive infrared (PIR) sensor), an active reflected wave sensor (e.g. a radar that detects motion, such as based on a detected change in position and/or based on a Doppler measurement), a thermal sensor, a magnetic sensor, a proximity sensor, a threshold sensor, a door sensor and a window sensor. Notably, other sensors may also be provided to monitor further locations in the environment, although only two sensors will be described here for simplicity.

An active reflected wave detector may operate in accordance with one of various reflected wave technologies. In operation, the CPU 300 may use the input from the active reflected wave detector to determine the presence (i.e. location) and/or direction of travel of the target object (e.g. person 104).

Preferably, the active reflected wave detector is a radar sensor. The radar sensor may use millimeter wave (mmWave) sensing technology. The radar is, in some embodiments, a continuous-wave radar, using, for example, frequency modulated continuous wave (FMCW) technology. Such a chip with such technology may be, for example, Texas Instruments Inc. part number IWR6843. The radar may operate in microwave frequencies, e.g. in some embodiments a carrier wave in the range of 1-100 GHz (76-81 Ghz or 57-64 GHz in some embodiments), and/or radio waves in the 300 MHz to 300 GHz range, and/or millimeter waves in the 30 GHz to 300 GHz range. In some embodiments, the radar has a bandwidth of at least 1 GHz. The active reflected wave detector may comprise antennas for both emitting waves and for receiving reflections of the emitted waves, and in some embodiments different antennas may be used for the emitting compared with the receiving.

As will be appreciated the active reflected wave detector is an “active” detector in the sense of it relying on delivery of waves from an integrated source in order to receive reflections of the waves. Thus, the active reflected wave detector need not be limited to being a radar sensor. In other embodiments, the active reflected wave detector may comprise a lidar sensor, or a sonar sensor.

The active reflected wave detector being a radar sensor is advantageous over other reflected wave technologies in that radar signals may transmit through some materials, e.g. wood or plastic, but not others-notably water, which is important because humans are mostly water. This means that the radar can potentially “see” a person in the environment even if they are behind an object of a radar-transmissive material. This may not be the case for sonar.

Each of the first and second sensors 102a, b may have a field of view. The first sensor 102a and the second sensor 102b may or may not be arranged such that their fields of view overlap. The fields of view of the first sensor 102a and the second sensor 102b may partially or fully overlap. Thus, there may be at least a partial overlap between the fields of view of the first sensor 102a and the second sensor 102b.

The overlapping, or partial overlapping, of the fields of view is, in some embodiments, in the 3D sense. However in other embodiments the overlapping, or partial overlapping, of the fields of view may be in a 2D, plan view, sense. For example, there may be an overlapping field of view in X and Y axes, but with a non-overlap in a Z axis.

In some embodiments, the CPU 300 is configured to control the camera 310 to capture at least one image (represented by image data) of the environment. The images may be still images or moving images in the sense of a video capture. The camera 310 is preferably a visible light camera in that it senses visible light. In other embodiments, the camera 310 senses infrared light.

One example of a camera which senses infrared light is a night vision camera which operates in the near infrared (e.g. wavelengths in the range 0.7-1.4 μm) which requires infrared illumination e.g. using infrared LEDs which are not visible to an intruder. Another example of a camera which senses infrared light is a thermal imaging camera which is passive in that it does not require an illumination source, but rather, senses light in a wavelength range (e.g. a range comprising 7 to 15 μm, or 7 to 11 μm) that includes wavelengths corresponding to blackbody radiation from a living person (around 9.5 μm). The camera 310 may be capable of detecting both visible light and, for night vision, near infrared light.

The system 100 comprises a first output device 116a and a second output device 116b, each configured for outputting deterrents to an intruder in the environment. For example, the first and/or second output device 116a, b may comprise a visual output device in the form of a lighting device. The lighting device may comprise one or more light sources for emitting visible light into the environment. In some embodiments the lighting device comprises multiple light sources. In embodiments in which the lighting device comprises multiple light sources, the multiple light sources are configured to illuminate a plurality of regions of the environment. As will be described in more detail below, the CPU 300 may selectively control one or more of the multiple light sources to emit a beam of light to a subset (e.g. one region or a cluster of regions) of the plurality of regions to illuminate an intruder wherever they are located. The one or more light sources are preferably LEDs due to their low power consumption which is advantageous for battery powered devices, but it will appreciated that other types of light source may be used. The lighting device may be coupled to the first and/or second output device 116a,b by way of a wired and/or wireless connection. Alternatively or additionally, the lighting device may be coupled to the hub device 106 by way of a wired and/or wireless connection.

Additionally or alternatively, the first and/or second output device 116a, b may comprise an audible output device in the form of a speaker for emitting audio. The term “audio” is used herein to refer to sound having a frequency that is within the human auditory frequency range, commonly stated as 20 Hz-20 kHz. The speaker may be coupled to the first and/or second output device 116a,b by way of a wired and/or wireless connection. Alternatively or additionally, the speaker may be coupled to the hub device 106 by way of a wired and/or wireless connection.

Additionally or alternatively, the first and/or second output device 116a, b may comprise a device for emitting one or more of: tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent. Ideally, the second output device 116b is triggered after the first put device 116a and comprises a deterrent having a more severe effect on an intruder than the first deterrent.

In the present embodiment, the first output device 116a comprises both a lighting device and a speaker and the second output device 116b comprises a device for emitting visible-light obscuring matter (smoke in an exemplary embodiment) to suspend particles in the air that make it difficult for a person to see. The first sensor 102a is a motion sensor and the second sensor 102b is an active reflected wave detector.

In relation to the active reflected wave detector, for each reflected wave measurement, for a specific time in a series of time-spaced reflected wave measurements, the reflected wave measurement may include a set of one or more measurement points that make up a “point cloud”, the measurement points representing reflections from respective reflection points from the environment. In each of the embodiments described herein the point cloud may be analysed by one or more processors (e.g. a CPU) in the active reflective wave detector device. Such analysis may include for example detecting, identifying (e.g. as potentially human or not), locating (e.g. by coordinates and/or with respect to a region of interest) and/or tracking an object. This may be the case for example in embodiments where such a device indicates the output of such analysis, over a wireless communication, to another device, e.g. hub device 106, monitoring station 110, or the remote server 112. In embodiments described herein, for example immediately hereinafter, in which such analysis is conducted by the CPU of the hub device 106, it will be appreciated that in each such embodiment some or all of the analysis may instead be performed in the active reflective wave detector device.

In some embodiments, the active reflected wave detector provides an output to the CPU 300 for each captured frame as a point cloud for that frame. Each point in the point cloud may be defined by a 3-dimensional spatial position from which a reflection was received, and defining a peak reflection value, and a doppler value from that spatial position. Thus, a measurement received from a reflective object may be defined by a single point, or a cluster of points from different positions on the object, depending on its size.

In some embodiments, such as in the examples described herein, the point cloud represents only reflections from moving points of reflection, for example based on reflections from a moving target. That is, the measurement points that make up the point cloud represent reflections from respective moving reflection points in the environment. This may be achieved for example by the active reflected wave detector using moving target indication (MTI). Thus, in these embodiments there must be a moving object in order for there to be reflected wave measurements from the active reflected wave detector (i.e. measured wave reflection data), other than noise. In other embodiments, the CPU 300 receives a point cloud from the active reflected wave detector for each frame, where the point cloud has not had pre-filtering out of reflections from moving points. Preferably, for such embodiments, the CPU 300 filters the received point cloud to remove points having Doppler frequencies below a threshold to thereby obtain a point cloud representing reflections only from moving reflection points. In both of these implementations, the CPU 300 accrues measured wave reflection data which corresponds to point clouds for each frame whereby each point cloud represents reflections only from moving reflection points in the environment.

In some embodiments, no moving target indication (or any filtering) is used. In these implementations, the CPU 300 accrues measured wave reflection data, which corresponds to point clouds for each frame whereby each point cloud can represent reflections from both static and moving reflection points in the environment.

In a map of reflections, the size of the point may represent an intensity (magnitude) of energy level of the radar reflections. Different parts or portions of the body reflect the emitted signal (e.g. radar) differently. For example, generally, reflections from areas of the torso are stronger than reflections from the limbs. Each point represents coordinates within a bounding shape for each portion of the body. Each portion can be separately considered and have separate boundaries, e.g. the torso and the head may be designated as different portions. The point cloud can be used as the basis for a calculation of a reference parameter or set of parameters which can be stored instead of or in conjunction with the point cloud data for a reference object (e.g. human) for comparison with a parameter or set of parameters derived or calculated from a point cloud for radar detections from an object (e.g. human).

When a cluster of measurement points are received from an object in the environment, a location of a particular part/point on the object or a portion of the object, e.g. its centre, may be determined by the CPU 300 from the cluster of measurement point positions having regard to the intensity or magnitude of the reflections (e.g. a centre location comprising an average of the locations of the reflections weighted by their intensity or magnitude). A reference body may have a point cloud from which its centre has been calculated and represented by a location. In this embodiment, the torso of the body is separately identified from the body and the centre of that portion of the body is indicated. In other embodiments, the body can be treated as a whole or a centre can be determined for each of more than one body part e.g. the torso and the head, for separate comparisons with centres of corresponding portions of a scanned body.

In one or more embodiments, the object's centre or portion's centre is in some embodiments a weighted centre of the measurement points. The locations may be weighted according to a Radar Cross Section (RCS) estimate of each measurement point, where for each measurement point the RCS estimate may be calculated as a constant (which may be determined empirically for the reflected wave detector) multiplied by the signal to noise ratio for the measurement divided by R⁴, where R is the distance from the reflected wave detector antenna configuration to the position corresponding to the measurement point. In other embodiments, the RCS may be calculated as a constant multiplied by the signal for the measurement divided by R⁴. This may be the case, for example, if the noise is constant or may be treated as though it were constant. Regardless, the received radar reflections in the exemplary embodiments described herein may be considered as an intensity value, such as an absolute value of the amplitude of a received radar signal.

In any case, the weighted centre, WC, of the measurement points for an object may be calculated for each dimension as:

$$WC = \frac{1}{{Σ}_{n = 1}^{N} {W}_{n}} {\sum }_{n = 1}^{N} ( {W}_{n} {P}_{n} )$$

Where:
N is the number of measurement points for the object;
Wₙ is the RCS estimate for the n^{th} measurement point; and
Pₙ is the location (e.g. its coordinate) for the n^{th} measurement point in that dimension.

Operation of the system 100 will now be described in relation to some particular, non-limiting, scenarios.

In a first scenario, the CPU 300 receives input from the first sensor 102a, which is a PIR motion sensor, when a person enters its field of view. The input is in the form of a signal only output from the first sensor 102a when a PIR signal is sensed. In other embodiments, the first sensor 102a may output a signal periodically, where the signal is indicative of a sensed condition and the amplitude of the signal is used to determine with a PIR signal has been sensed. The CPU 300 may recognise the input as deriving from the first sensor 102a by an identifier included in the input. In some embodiments, a characteristic of the input may denote which sensor the input has been received from.

Based on the input, the CPU 300 is able to determine whether an object 104 such a human has been sensed by the first sensor 102a and to record a time when such an object is detected as a first time in the memory 302. The presence of an input from the first sensor 102a may be sufficient to determine that an object has been detected or the input may be analysed to determine whether an object (e.g. human) has been detected, for example, based on an amplitude or frequency of the input. In some embodiments, it may be assumed that an object such as a human has been detected if anything is detected by the first sensor 102a. If the first sensor 102a is arm-aware, it may only output a signal to the CPU 300 when the system 100 is armed and an object is detected. However, if the first sensor 102a is arm-unaware, it may always output a signal to the CPU 300 when an object is detected and the CPU 300 may determine whether to act on the basis of the input depending on whether the system 100 is armed at the time of the detection. If the system 100 is armed and an object is detected by the first sensor 102a, the CPU 300 will output a first instruction to the first output device 116a for outputting a first deterrent. In this embodiment, the first instruction triggers a flashing light and audio alarm as the first deterrent.

If the intruder is not deterred by the first deterrent and continues to enter the home, the second sensor 102b, which is a radar detector, will detect the intruder when he/she enters the field of the view of the second sensor 102b and the CPU will receive input from the second sensor 102b to this effect. The input from the second sensor 102b may be in the form of a signal only output from the second sensor 102b when a moving object is detected, as detailed above. In other embodiments, the second sensor 102b may output a signal periodically, where the signal is indicative of a sensed condition and the signal may be analysed by the CPU 300 to determine whether an object such as a human has been detected. The CPU 300 may recognise the input as deriving from the second sensor 102b by an identifier included in the input. In some embodiments, a characteristic of the input (e.g. signal strength) may denote which sensor the input has been received from.

Based on the input, the CPU 300 is able to determine whether an object 104 such a human has been sensed by the second sensor 102b and to record a time when such an object is detected as a later time (for example, a predetermined amount of time, e.g. seconds, after the first time) in the memory 302. The presence of an input from the second sensor 102b may be sufficient to determine that an object has been detected or the input may be analysed to determine whether an object (e.g. human) has been detected. In some embodiments, it may be assumed that an object such as a human has been detected if anything is detected by the second sensor 102b. It may also be assumed that the object detected at the later time is the same object as that detected at the first time, although this may not always be the case. If the second sensor 102b is arm-aware, it may only output a signal to the CPU 300 when the system 100 is armed and an object is detected. However, if the second sensor 102b is arm-unaware, it may always output a signal to the CPU 300 when an object is detected and the CPU 300 may determine whether to act on the basis of the input depending on whether the system 100 is armed at the time of the detection. If the system 100 is armed and an object is detected by the second sensor 102b, the CPU 300 will identify the location of the object 104 at the later time and determine whether a predetermined condition is met with respect to the location at the later time. The location of the object may be determined based on an identification of the sensor from which the input was received at the later time and the location associated with said sensor, as may be stored in a look-up table in the memory 302. In some embodiments, the location within a sensor's field of view may be determined, for example, as outlined above for the case of a radar detector.

The predetermined condition may be that the later time is within a pre-defined time window with respect to the first time (e.g. within a period of 10s to 60s). If the predetermined condition is met, the CPU 300 will output a second instruction to another device, the second instruction being associated with a process for outputting a second deterrent. The another device in this case may be the second output device 116b but, where the second deterrent is potentially more harmful than simply light or audio, the another device may be the monitoring station 110, the remote server 112 or the user device 114. For example, the CPU may control the camera 310 to capture at least one image of the environment; may instruct said image to be displayed on a display device of the monitoring station 110; and may prompt an operator for confirmation to begin outputting the second deterrent. If the operator can see a potential intruder in the image displayed and confirms that the second deterrent be output via a user input, an instruction to that effect will be sent from the monitoring station 110 to the CPU 300 and the CPU 300 will instruct the second output device 116b to output the second deterrent. In this case, the second deterrent is visible-light obscuring matter (e.g. smoke) although other deterrents may be used as mentioned previously. Also, in this embodiment, the output of the first deterrent of light and audio is continued alongside the output of the second deterrent. In other embodiments, the output of the first deterrent may be ceased when the second deterrent is output. The second deterrent may be output continuously or intermittently for one or more pre-determined periods of time, for example, upon receipt of further confirmation from the operator to continue the output.

In summary, a person may be detected in any of one or more locations associated with respective sensors, the locations may be a subset of the locations associated with all of the sensors. For example, a subset of motion sensors; or in another example, any motion sensor, but not a door sensor, so that it is clear that the person is still inside the house or other environment being monitored. If a door sensor or other similar sensor is triggered at the later time, this may indicate that the person has left the environment, especially if no motion inside the environment is detected during a predefined timeframe thereafter. In this case, the predetermined condition may not be met for outputting the second instruction.

It will be understood that the person need not have moved from an area sensed by one sensor to an area sensed by another sensor by the later time. In some instances, the person may be detected by the same sensor at the first time and the later time. This may indicate that the person has not progressed through the environment but also has not left the environment. Depending on whether the predetermined condition is met, the system 100 may or may not output the second instruction in this scenario.

Another example is that a radar (or other active reflected wave measuring device) detects the person (wherein a radar covers a subset of the associated locations; or it could be that the person is within a specific area of interest within the region monitored by the radar (e.g. a region defined by a virtual fence).

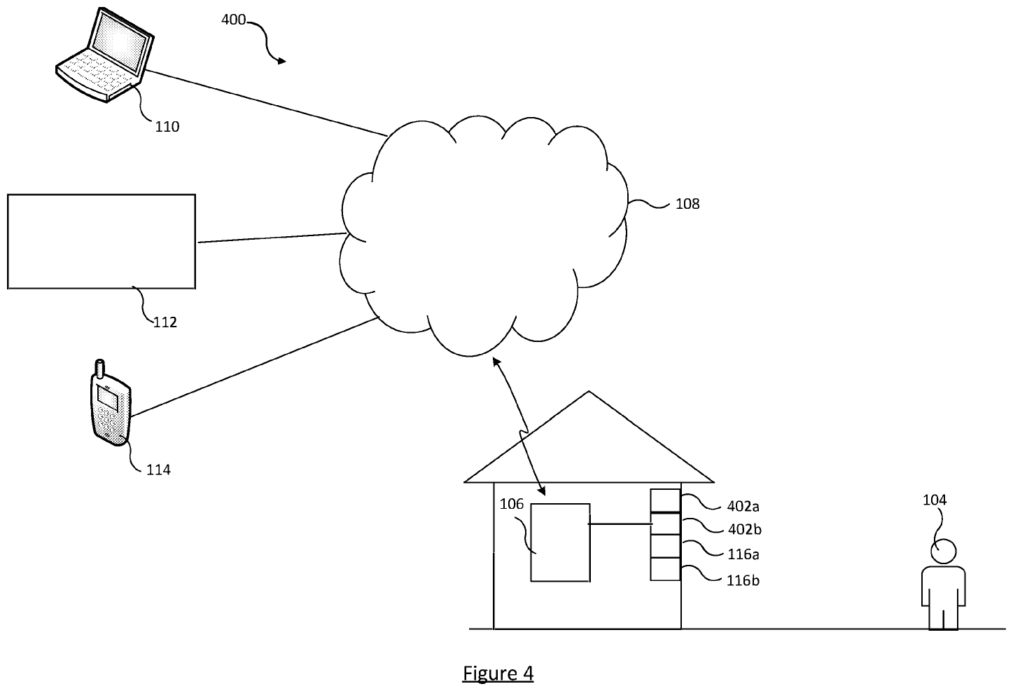

FIG. 4 illustrates a second system 400, having co-located sensors 402a, 402b in an environment, according to a second embodiment of the invention. The system 400 is similar to the system 100 of FIGS. 1 and 3 and like reference numerals are used for like components. Both sensors 402a, 402b are mounted on the interior wall of the house and have overlapping fields of view. Both output devices 116a, 116b are also mounted on the interior wall for outputting the first and second deterrents. In this embodiment, the first sensor 402a is a PIR motion sensor and the second sensor 402b is an active reflected wave detector, such as described above.

The CPU 300 in the hub device 106 controls the active reflected wave detector to measure wave reflections from the environment so that the CPU 300 accrues measured wave reflection data in response to the PIR motion sensor detecting motion in the environment. That is, in response to determining that the first sensor 402a has detected motion in the environment based on receiving an output signal indicative of detected motion from the PIR motion sensor, the CPU 300 operates the second sensor 402b. The CPU 300 may also output a first instruction to the first output device 116a for outputting a first deterrent (e.g. light and/or audio) upon motion detected by the motion detector.

Prior to the sensing of motion by the first sensor 402a, the active reflected wave detector may be in a deactivated state. In the deactivated state the active reflected wave detector may be turned off. In some embodiments, in the deactivated state the active reflected wave detector may be turned on but in a low power consumption operating mode whereby the active reflected wave detector is not operable to perform reflected wave measurements. In these implementations, the CPU 300 activates the active reflected wave detector so that it is in an activated state and operable to measure wave reflections from a monitored area of the environment. The monitored area may correspond to the field of view of the active reflected wave detector.

As described in more detail below, rather than controlling the second output device 116b to output a severe deterrent in response to the detected motion, the CPU 300 processes data output by the active reflected wave detector to determine whether the second deterrent should be output.

More specifically, the CPU 300 processes the measured wave reflection data to determine whether an object is present in the environment. Various techniques may be used to perform this step. In one possible implementation, this step may be performed using a tracking module in the CPU 300 and the CPU 300 determines that an object is present in the environment because a cluster of detection measurements (also referred to as measurement points above) can be tracked by the tracking module.

The tracking module can use any known tracking algorithm. For example, the active reflected wave detector may generate a plurality of detection measurements (e.g. up to 100 measurements, or in other embodiments hundreds of measurements) for a given frame. Each measurement can be taken a defined time interval apart such as 0.5, 1, 2 or 5 seconds apart. Each detection measurement may include a plurality of parameters in response to a received reflective wave signal above a given threshold. The parameters for each measurement may for example include an x and y coordinate (and z coordinate for a 3D active reflected wave detector), a peak reflection value, and a Doppler value corresponding to the source of the received radar signal.

The data can then be processed using a clustering algorithm to group the measurements into one or more measurement clusters corresponding to a respective one or more targets. An association block of the tracking module may then associate a given cluster with a given previously measured target. A Kalman filter of the tracking module may then be used to estimate the next position of the target based on the corresponding cluster of measurements and a prediction by the Kalman filter of the next position based on the previous position and one or more other parameters associated with the target, e.g. the previous velocity. As an alternative to using a Kalman filter other tracking algorithms known by the person skilled in the art may be used.

The tracking module may output values of location, velocity and/or RCS for each target, and in some embodiments also outputs acceleration and a measure of a quality of the target measurement, the latter of which is essentially to act as a noise filter. The values of position (location) and velocity (and acceleration, if used) may be provided in 2 or 3 dimensions (e.g. cartesian or polar dimensions), depending on the embodiment.

The Kalman filter tracks a target object between frames and whether the Kalman filter's estimation of the objects' parameters converges to the object's actual parameters may depend on the kinematics of the object. For example, more static objects may have a better convergence. The performance of the Kalman filter may be assessed in real time using known methods to determine whether the tracking meets a predefined performance metric, this may be based on a covariance of the Kalman filter's estimation of the object's parameters. For example, satisfactory tracking performance may be defined as requiring at least that the covariance is below a threshold. Depending on the object's motion, the Kalman filter may or may not produce satisfactory performance within a predefined number of frames (e.g. 3-5 frames). The frames may be taken at a rate of 10 to 20 frames per second, for example. If the RCS is outside that range it may be concluded that the object is inhuman.

If no object is detected by the active reflected wave detector, the process may end without a second deterrent being output by the second output device 116b.

If an object is detected, the CPU 300 determines whether a first predetermined condition in respect of the object is met.

For example, the CPU 300 may determine whether the detected object is human or not. Any known method for detecting whether the object is human or not can be used. In particular, determining whether the detected object is human may not use a reference object such as that described above. In one example, this step may be performed using the tracking module referred to above.

In some implementations, the RCS of the object may be used to determine whether the detected object is human or not. In particular, from the reflected wave measurements an RCS of an object represented by a cluster of measurement points can be estimated by summing the RCS estimates of each of the measurement points in the cluster. This RCS estimate may be used to classify the target as a human target if the RCS is within a particular range potentially relevant to humans for the frequency of the signal emitted by the active reflected wave detector, as the RCS of a target is frequency dependent. Taking a 77 GHz radar signal as an example, from empirical measurements, the RCS (which is frequency dependent) of an average human may be taken to be in the order of 0.5 m², or more specifically in a range between 0.1 and 0.7 m², with the value in this range for a specific person depending on the person and their orientation with respect to the radar. The RCS of a human in the 57-64 GHz spectrum is similar to the 77 GHZ RCS—i.e. 0.1 and 0.7 m². If the RCS is outside that range it may be concluded that the object is inhuman.

Additionally or alternatively, the velocity information associated with the object may be used to determine whether the detected object is human or not. For example, it may be concluded that no human is present if there is no detected object having a velocity within a predefined range and/or having certain dynamic qualities that are characteristic of a human.

The above examples are ways of determining that the object is human, which may reflect that the object is likely to be human, or fails a test which would determine that the object is inhuman thereby implying that the object is potentially human. Thus, it will be appreciated by persons skilled in the art that there may be a significant level of error associated with the determination that the object is human.

If the detected object is determined not to be human (e.g. the object is a pet or other animal), the process may end without a second deterrent being output by the second output device 116b. This advantageously avoids unnecessary/nuisance triggering of the second output device when it can be determined that the object is not an intruder and thus saves power consumption.

In another example, the CPU 300 may determine whether the object is located in a predetermined area within the field of view of the active reflected wave detector. As discussed above, such location information may be provided by the tracking module referred to above. The predetermined area within the field of view of the active reflected wave detector may correspond to a region defined by a virtual fence within the field of view of the active reflected wave detector. During installation of the second sensor 102b, the installer will switch the second sensor 102b to a calibration or configuration mode for the defining of the virtual fence. Exemplary methods for an installer to define such a virtual fence is described in International patent application number PCT/IL2020/050130, filed 4 Feb. 2020, the contents of which are incorporated herein by reference. However, other methods of defining a virtual fence may be employed. A virtual fence described herein is not necessarily defined by co-ordinates that themselves define an enclosed area. For example, an installer may simply define a line extending across the field of view of the active reflected wave detector and then configure the virtual fence to encompass an area that extends beyond this line (further away from the active reflected wave detector) and is bound by the field of view and range of the active reflected wave detector. In another example, the encompassed area may correspond to the region detectable by the active reflected wave detector that is closer than the line.

If an object is located in the predetermined area within the field of view of the active reflected wave detector this indicates a possible security threat, whereas if the object is outside of the predetermined area this indicates that even though an object is present their presence is not deemed a security threat, or at least not of a sufficient threat to output a deterrent. If the detected object is located outside of the predetermined area, the process ends without a second deterrent being output by the second output device 116b. This advantageously avoids triggering of the second output device 116b when it can be determined that the presence of the object is not a security concern and thus saves power consumption.

It will be appreciated that other predetermined conditions in respect of the object may be checked that are not described herein.

If the CPU 300 determines that the first predetermined condition in respect of the object is met, the CPU 300 determines that an intruder is present in an area of interest, and the process proceeds. In embodiments whereby a virtual fence is used in the determination, the “area of interest” corresponds to a portion of the monitored area of the environment. In embodiments whereby no virtual fence is used in the determination, the “area of interest” may correspond to the entire monitored area of the environment. As noted above, the monitored area of the environment may for example correspond to the field of view of the active reflected wave detector.

It will be appreciated that more than one virtual fence may be defined within the field of view of the active reflected wave detector, and thus there may be more than one area of interest in the monitored area of the environment.

Next, the CPU 300 controls the second output device 116 to output a second deterrent. Thus, the output of the second deterrent is triggered based on a predetermined condition being met based on an output of the active reflected wave detector which provides more relevant triggering than triggering only based on the output of a motion sensor.

In some embodiments, the first deterrent is not triggered until a predetermined condition is met based on an output of the active reflected wave detector. In which case, the second deterrent may be output subsequently based on a location of the intruder at a later time. When the first deterrent is to be output, the CPU 300 may control a lighting device to emit light as a visual deterrent to the intruder.

As noted above, the lighting device may comprise one more light sources, and the CPU 300 may control the lighting device to emit light from all of the one or more light sources wherein the light source(s) were not emitting light previously. That is, all of the light sources(s) of the lighting device may be turned on.

In other implementations the light emitted by the lighting device is targeted onto the intruder. In these embodiments, the lighting device comprises multiple light sources which are configured to illuminate a plurality of regions of the environment. The CPU 300 processes the accrued measured wave reflection data to determine a location of the intruder in the environment and to selectively control one or more of the multiple light sources to emit a beam of light to selectively illuminate the determined location by selecting a subset (e.g. one region or a cluster of regions) of the regions. That is, one or more of the multiple light sources are selected to shine a beam on the person wherever they are identified as being from the output of the active reflected wave detector, thus giving them an uneasy feeling that they are being watched, or are exposed or more visible.

In some embodiments, a housing of the lighting device that holds one or more light sources may be moveably mounted with respect to a mounting component or assembly (e.g. a bracket). For example the housing of the lighting device may pivot and/or swivel with respect to mounting component or assembly. The relative disposition of the housing of the lighting device with respect the mounting component or assembly may be controlled by one or more motors to enable the direction of illumination to be controlled, as needed.

In any case, the location of the person may be tracked and the illuminated location may change to track the location of the person. In the case of the lighting array, this may be achieved by selecting a different subset of the plurality of illumination regions. In the case of a moveable housing of the lighting device that holds the light source(s), this may be achieved by appropriately actuating the motor(s).

The light source(s) of the lighting device that are controlled to emit light may be controlled to constantly emit light, or may be controlled to emit flashing light.

Additionally or alternatively, the CPU 300 may control a speaker to emit audio as an audible deterrent to the intruder. The audio emitted by the speaker may be a non-speech sound e.g. a warning siren. Additionally or alternatively the audio emitted by the speaker may be an audible speech message e.g. “this is private property, please leave immediately!”.

If the CPU 300 determines that the first predetermined condition in respect of the object is met the CPU 300 will transmit an alert message to one or more of the remote monitoring station 110, the server 112 and the user device 114. If the previous step of the CPU 300 is not carried out in the hub device 106, the CPU 300 may, additionally or alternatively, transmit the alert message via the hub device 106 to one or more of the remote monitoring station 110, the server 112 and the user device 114.

Optionally, if the CPU 300 determines that the first predetermined condition in respect of the object is met and the CPU 300 is coupled to a camera 310, the CPU 300 may additionally control the camera 310 to capture an image of said environment. In response to receiving image data associated with a captured image from the camera 310, the CPU 300 may transmit the image data to the control hub 106 for subsequent transmission to one or more of the remote monitoring station 110, the server 112 and the user device 114. Additionally or alternatively the CPU 300 may transmit the image data directly to one or more of the remote monitoring station 110, the server 112 and the user device 114.

The process may end after the first output device 116a outputs the first deterrent, for example, if the object 104 is not further detected within a pre-defined interval from activation of the first deterrent. In which case, the CPU 300 may instruct the first output device 116a to cease outputting of the first deterrent.

However, in some scenarios the process may continue to determine whether it is necessary to output a second deterrent that is to act as an escalated warning of increasing severity e.g. depending on where the person is located and/or their direction of travel and/or other kinetic information. This is described in more detail below.

Thus, after a predetermined time period has elapsed after output of the first deterrent, the CPU 300 processes further measured wave reflection data accrued by the active reflected wave detector to determine whether a second predetermined condition related to the object is met. Once the CPU 300 has accrued sufficient measured wave reflection data in order to make the determination, the CPU 300 may control the active reflected wave detector to be in a deactivated state to conserve power. In the deactivated state the active reflected wave detector may be turned off. In some embodiments, in the deactivated state the active reflected wave detector may be turned on but in a low power consumption operating mode whereby the active reflected wave detector is not operable to perform reflected wave measurements. In these implementations, the CPU 300 activates the active reflected wave detector so that it is in an activated state and operable to measure wave reflections from the monitored area of the environment.

Preferably, once the CPU 300 has accrued sufficient measured wave reflection data in order to make the determination the active reflected wave detector remains in an activated state for at least as long as the intruder is present in the area of interest. This enables the object to be tracked to see its velocity and/or to see if the object at a second time t2 (e.g. used in the assessment to determine whether the second predetermined condition is met) is the same object as at first time t1 (e.g. used in the assessment to determine whether the first predetermined condition is met).

In other implementations, the active reflected wave detector remains in an activated state throughout the process, i.e. it may be always in an activated state.

The second predetermined condition may be based at least on a location of the object in the environment.

For example, the first deterrent output may have been based on the object being located in a first predetermined area within a field of view of the active reflected wave detector, and the second predetermined condition may comprise that the object has remained in this predetermined area after the predetermined time period has elapsed. If this example second predetermined condition is met, this indicates that the intruder has not moved out of the area of interest despite the outputting of the first deterrent.

In another example, the first deterrent output may have been based on the object being located in a first predetermined area (e.g. a first region defined by a first virtual fence) within a field of view of the active reflected wave detector, and the second predetermined condition may comprise that the object has moved such that they are located in a second predetermined area (e.g. a second region defined by a second virtual fence) within the field of view of the active reflected wave detector. If this example second predetermined condition is met, this indicates that the intruder has moved into an area of interest that may be more of a concern despite the outputting of the first deterrent. The area of interest may be more of a concern by representing a greater security threat, for example by virtue of being closer to a building or other space to be secured.

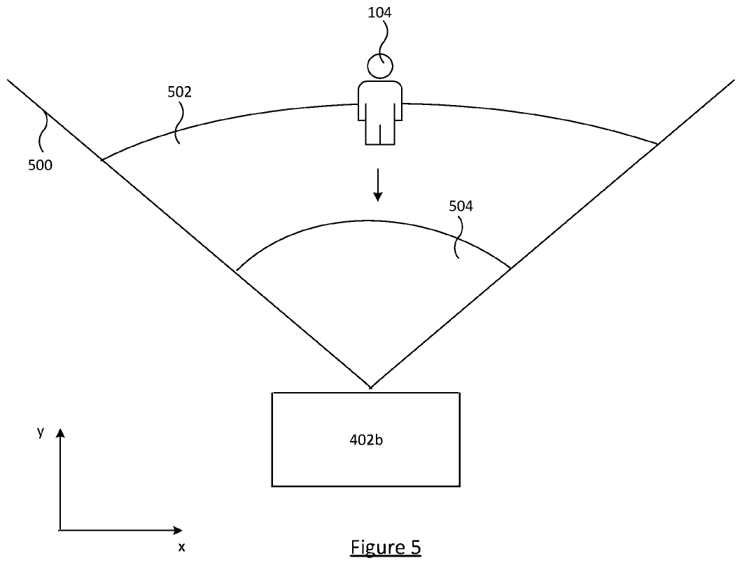

The predetermined condition may be based at least on a direction of travel of the object in the environment. For example, it could be that the object is moving (or has moved) towards the second predetermined area or towards a designated location. An example of an embodiment which involves a first predetermined area and a second predetermined area is described below with reference to FIG. 5.

For example, the first deterrent output may have been based on the object 104 being located in a first predetermined area 502 (e.g. a first region defined by a first virtual fence) within a field of view 500 of the active reflected wave detector 402b, and the second predetermined condition may comprise that the object has moved towards a second predetermined area 504 (e.g. a second region defined by a second virtual fence) within the field of view 500 of the active reflected wave detector 402b. If this example second predetermined condition is met, this indicates that the intruder has not moved away from the area of interest in a desired direction despite the first output device 116a outputting the first deterrent and has instead moved in a direction towards a sensitive area that is more of a security threat (e.g. they have got closer to a building).

The first predetermined area 502 may be up to but not including the second predetermined area 504. In these examples the first predetermined area 502 may be contiguous with the second predetermined area 504, or the first predetermined area 502 may be non-contiguous with the second predetermined area 504.

In other implementations, the second predetermined area 504 may be inside (i.e. enclosed by) the first predetermined area 502.

Whilst FIG. 5 illustrates the first virtual fence and second virtual fence as both having sections which coincide with a portion of the perimeter of the area of the environment that is monitored by the active reflected wave detector, this is merely an example, and any virtual fence described herein need not have a portion that coincides with a portion of the perimeter of the area of the environment that is monitored by the active reflected wave detector.

Furthermore whilst the region within the second virtual fence 504 is shown as extending up to the active reflected wave detector 402b, this is merely an example. For example, an active reflected wave detector 402b may have limitations for the detection of objects within a certain distance of it and therefore an installer may be restricted on how close to the active reflected wave detector 402b they can define a section of the virtual fence.

The second predetermined condition may be based at least on kinetic information associated with the person e.g. their speed of travel. For example the second predetermined condition may be that the speed of the person does not exceed a predetermined threshold. If this example second predetermined condition is met, this may indicate that the intruder is moving out of the area of interest but are doing it too slowly, or they are simply not moving such that they are staying at the same location. The speed information may be provided by the tracking module referred to above.

If the CPU 300 determines that the second predetermined condition is met, the CPU 300 controls the second output device 116b to output a second deterrent. The second deterrent conveys a heightened sense of urgency that the intruder leaves the area.

The CPU 300 may control the lighting device to emit light as a visual deterrent to the intruder. Alternatively, or additionally the CPU 300 may control the speaker to emit audio as an audible deterrent to the intruder.

Examples are described below which illustrate how the CPU 300 may control the second output device 116b to output a second deterrent which conveys a heightened sense of urgency that the intruder leaves the area.

Taking the example where for the first deterrent the CPU 300 controls the lighting device to turn on all of the light source(s) of the lighting device, for the second deterrent the CPU 300 may control one or more of the multiple light sources of the the lighting device to shine a targeted beam on the person as described above. In some embodiments, the CPU 300 may control the light source(s) of the lighting device to flash for the second deterrent. Alternatively or additionally, the CPU 300 may control the speaker to emit audio as an audible second deterrent to the intruder in a manner as described above. Thus, in some embodiments, the first deterrent and the second deterrent may both comprise light and/or sound and may be output from a single output device. In other embodiments, the first deterrent may comprise light and/or sound and the second deterrent may comprise something other than light and sound. For example, the second deterrent may comprise one or more of: tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent. In which case, the second deterrent may only be output after confirmation to proceed is given by a user at the monitoring station 110 as described above.

Taking the example where for the first deterrent the CPU 300 controls the lighting device to emit flashing light, for the second deterrent the CPU 300 may control one or more of the multiple light sources of the the lighting device to shine a targeted beam on the person as described above. In some embodiments, the CPU 202 may control the light source(s) of the lighting device to flash at an increased frequency. Alternatively or additionally, the CPU 300 may control the speaker to emit audio as an audible deterrent to the intruder in a manner as described above.

Taking the example where for the first deterrent the CPU 300 controls the lighting device to shine a targeted beam (which may be flashing) on the person, for the second deterrent the CPU 300 may control the one or more of the multiple light sources emitting the beam of light to selectively illuminate the location of the intruder to emit a flashing beam at the location of the intruder. Alternatively or additionally, the CPU 300 may control the speaker to emit audio as an audible deterrent to the intruder in a manner as described above.

Taking the example where for the first deterrent the CPU 300 controls the speaker to emit a non-speech sound e.g. a warning siren, for the second deterrent the CPU 300 may control the speaker to increase the volume of the emitted non-speech sound, and/or change the alarm pattern of the non-speech sound. Alternatively or additionally, the CPU 300 may control the speaker to emit an audible speech message. Alternatively or additionally, the CPU 300 may control the lighting device to emit light as a visual deterrent to the intruder in a manner as described above.

Taking the example where for the first deterrent the CPU 300 controls the speaker to emit an audible speech message, for the second deterrent the CPU 300 may control the speaker to increase the volume of the emitted audible speech message and/or to output a different audible speech message. Alternatively or additionally, the CPU 300 may control the speaker to emit a non-speech sound e.g. a warning siren. Alternatively or additionally, the CPU 300 may control the lighting device to emit light as a visual deterrent to the intruder in a manner as described above.

If the CPU 300 determines that that the second predetermined condition is not met the process 400 may end without any further output by the output device.

In other embodiments, the CPU 300 determines whether a third predetermined condition is met, wherein meeting of the third predetermined condition is indicative of a person leaving a location (e.g. a spot or an area), and if the third predetermined condition is met, the CPU 300 performs at least one of: commanding a ceasing of an outputting of a deterrent (e.g. stops a siren and/or a visual deterrent) and/or controlling the speaker to output an audible speech message for encouraging the person to not return and/or to continue to leave. For example consider a case in which the first deterrent output was based on the object 104 being located in a first predetermined area 502 (e.g. a first region defined by a first virtual fence) within a field of view 500 of the active reflected wave detector. The third predetermined condition may be that the object 104 is identified as moving in a direction of leaving the first predetermined area, in which case, the CPU 300 may still control the speaker to emit an audible speech message to encourage the person to continue on their path. For example, the message may be “please continue to leave the area”. The third predetermined condition may comprise, or in some embodiments may more specifically be, that the second predetermined condition is not met. In some embodiments, there may be no second predetermined condition.

If the CPU 300 determines that the second predetermined condition in respect of the object is met the CPU 300 may additionally transmit an alert message to the control hub 106 for subsequent transmission to one or more of the remote monitoring station 110, the server 112 and the user device 114. Additionally or alternatively the CPU 300 may transmit the alert message directly to one or more of the remote monitoring station 110, the server 112 and the user device 114.

Optionally, if the CPU 300 determines that the second predetermined condition in respect of the object is met and the CPU 300 is coupled to the camera 310, the CPU 300 may additionally control the camera 310 to capture an image of said environment or a part thereof. In response to receiving image data associated with a captured image from the camera 310, the CPU 300 may transmit the image data to the control hub 106 for subsequent transmission to one or more of the remote monitoring station 110, the server 112 and the user device 114.

Additionally or alternatively the CPU 300 may transmit the image data directly to one or more of the remote monitoring station 110, the server 112 and the user device 114. Alternatively only a notification is transmitted, and the image data is only transmitted subsequently, if requested to do so by a remote device (e.g. the control hub 106, the remote monitoring station 110, the server 112, or the user device 114).

It will be appreciated from the above that a sequence of deterrents may be output after respective predetermined conditions are met (e.g. the first predetermined condition, which may simply be detection of an object at a first time, and the second predetermined condition, which may relate to the location and/or direction of travel of the object at a later time). This sequence of deterrents may comprise deterrents of different types. Thus it can be seen that in the process described above there may be an escalation, or a progressive escalation, to stronger deterrents as the security threat maintains or increases over time. Whilst the process has been described with reference to the sequence of deterrents comprising two types of deterrents for simplicity, it will be appreciated that the sequence of deterrents may comprise more than two types of deterrents, such further deterrents being output if further predetermined conditions are met based on processing further measured wave reflection data accrued by the active reflected wave detector or other sensor.

In embodiments of the invention whereby the system 100 monitors an outdoor environment of a residential property, if a first predetermined condition is met it may be advantageous to output a first deterrent that is unlikely to disturb (e.g. wake up) the occupants of the property. If the security threat remains or increases over time the likelihood of the occupants of the property being disturbed by way of subsequent deterrents being output may increase. This ensures that a person at home is not unnecessarily woken for a low risk threat but would be alerted for higher risk threats. Such escalation advantageously deters an intruder from getting close to or entering a property or particular area of interest.

Escalation of the deterrents is referred to below with reference to an example whereby the processor 300 monitors the presence of an intruder in four different zones of the monitored area of the environment. Each zone being progressively closer to the sensor 402b. It will be appreciated that embodiments of the present disclosure extend to any number of zones in the monitored area of the environment. Such zones may be user configured (e.g. defined by virtual fences). We refer below to example deterrents which may be output when an intruder is detected in each of these zones.

If the CPU 300 determines that an object is detected but it is located in an outer zone within the field of view of the active reflected wave detector, the CPU 300 may not output any deterrent.

If the CPU 300 determines that an object has moved from the outer zone towards the sensor 402b into a warning zone, the CPU 300 controls the lighting device to emit light as a visual deterrent to the intruder in one of the various ways as described above with respect to the first deterrent output. In one example, the CPU 300 controls the lighting device to emit flashing light at a lower frequency that is within a first frequency range defined by lower and upper frequency values. The CPU 300 may optionally additionally control the speaker to emit audio in the form of auditory beeping as an audible deterrent to the intruder.

If the CPU 300 determines that an object has moved from the warning zone towards the sensor 402b into a second deterrent zone, the CPU 300 controls the lighting device to emit light as an escalated visual deterrent to the intruder in one of the various ways as described above. In one example, the CPU 300 controls the lighting device to emit flashing light at a higher frequency that is within a second frequency range defined by lower and upper frequency values. The CPU 300 may optionally additionally control the speaker to emit more intensive audio e.g. auditory beeping with increased volume or having a different alarm pattern to the previously output auditory beeping, or audio in the form of an audible speech message (e.g. telling the intruder to leave). The CPU 300 may additionally or alternatively control the second output device 116b to output a more severe deterrent, for example, in the form of a light-obscuring material (e.g. smoke) to obstruct the intruder's path and/or cause disorientation.

After a predetermined time period has elapsed after output of the second deterrent, the CPU 300 may process further measured wave reflection data accrued by the active reflected wave detector to determine that an object has moved from the second deterrent zone towards the sensor 402b into an alarm zone (which in this illustrative example is the inner most zone located closest to the sensor 402b). In response to this determination the CPU 300 controls the speaker to emit audio in the form of an alarm siren. The CPU 300 may additionally control the lighting device to emit light as a visual deterrent to the intruder in a manner as described above. The CPU 300 may additionally transmit an alert message to one or more of the remote monitoring station 110, the server 112 and the user device 114 (either directly or via the hub device 106). The CPU 300 may additionally or alternatively control the second output device 116b to output a further severe deterrent, for example, in the form of a pepper spray.

In implementations described above, when the lighting device emits flashing light the light may be emitted with a constant duty cycle (e.g. at a 50% duty cycle). Alternatively the flashing could occur periodically. The duty cycle for any given zone referred to above may be constant or it may vary over time (e.g. varying between a lower duty cycle value and an upper duty cycle value). Similarly, the frequency of the light emitted for any given zone referred to above may be constant or it may vary over time (e.g. varying between a lower frequency value and an upper frequency value).

Whilst the above embodiments have been described above with reference to the CPU 300 of the hub device 106 performing all of the steps in the process, this is just an example. Functions that are described herein as being performed by the CPU 300 may be performed on a distributed processing system that is distributed amongst a plurality of separate apparatuses.

For example, the processing of measured wave reflection data and the determination as to whether any of the described predetermined conditions are met may be performed by the processor of a remote device that is remote from the hub device 106, e.g. associated with one or more of the sensors. In these embodiments the CPU 300 transmits the measured wave reflection data to the remote device for processing.

In some embodiments, the CPU 300 may be provided in the server 112 or monitoring station 110 and there may be no hub device 106. In which case, the sensors 402a, 402b and/or output devices 116a, 116b (which optionally may be integrated into one device) may communicate directly with the server 112 or monitoring station 110 (e.g. via a cellular network).

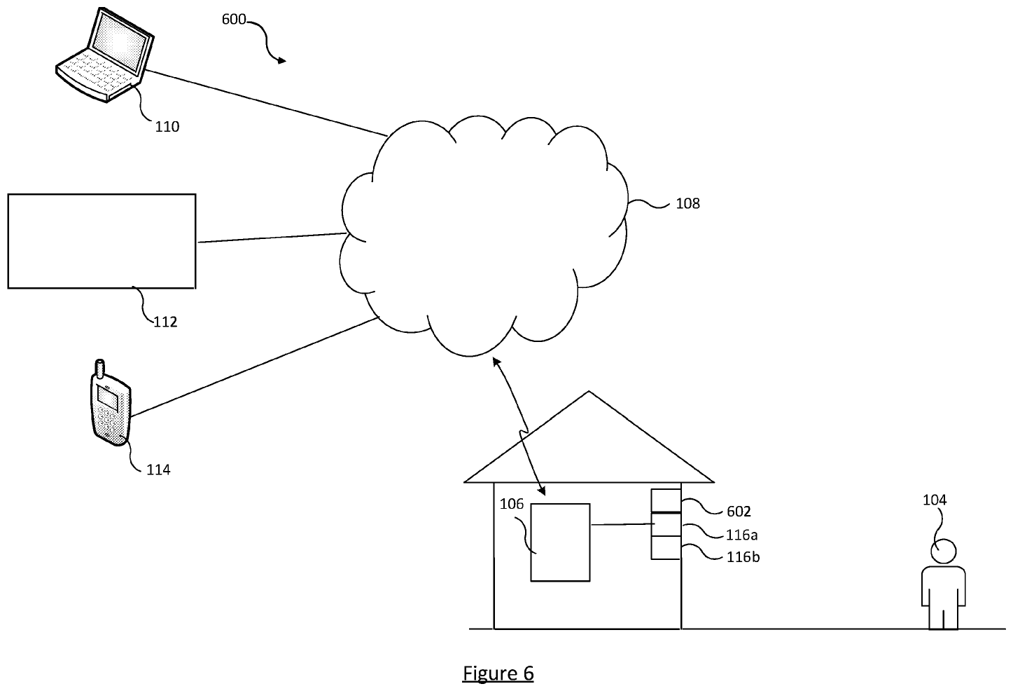

FIG. 6 illustrates a third system 600 employing a single active reflected wave detector 602 in an environment, according to a third embodiment of the invention. The active reflected wave detector may be the same as sensor 402b. The system 600 is similar to those described above but employs only a single sensor (in this case a radar detector) associated with a plurality of regions in the environment, for example, as illustrated in FIG. 5.

When an intruder is first detected by the active reflected wave detector 602 (i.e. at a first time), a signal is sent to the CPU 300 and the CPU 300 instructs the first output device 116a to output a first deterrent in the form a light and/or audio deterrent as described above. The CPU 300 then waits for a predetermined period before checking whether the active reflected wave detector 602 is still able to sense the intruder. If the intruder is still in the field of view of the active reflected wave detector 602 at the later time, the CPU may determine the location of the intruder within the field of view, from the active reflected wave signals. In some embodiments, the CPU 300 will determine the direction of travel of the intruder at the later time, from the active reflected wave signals, as described above. In this example, the location or direction of the intruder at the first time need not be known. If the location or direction or travel of the intruder is in or towards a predefined location, the predetermined condition will be met and the CPU 300 will output an instruction to another device (e.g. the second output device 116b and/or the monitoring station 110), the instruction being associated with a process for outputting a second deterrent. For example, the monitoring station 110 may be instructed to request confirmation from an operator to proceed with output of the second deterrent, which may be visible-light obscuring matter (e.g. smoke or fog), and the CPU 300 may only instruct the second output device 116b to proceed with output of the second deterrent after receipt of said confirmation to proceed.

In other embodiments, the direction of travel of the intruder may be determined using a system comprising a first motion sensor and a second motion sensor, wherein each sensor detects motion at a different time and the direction of travel is determined based on the location of the respective motion sensors and the order in which they each sensed the motion.

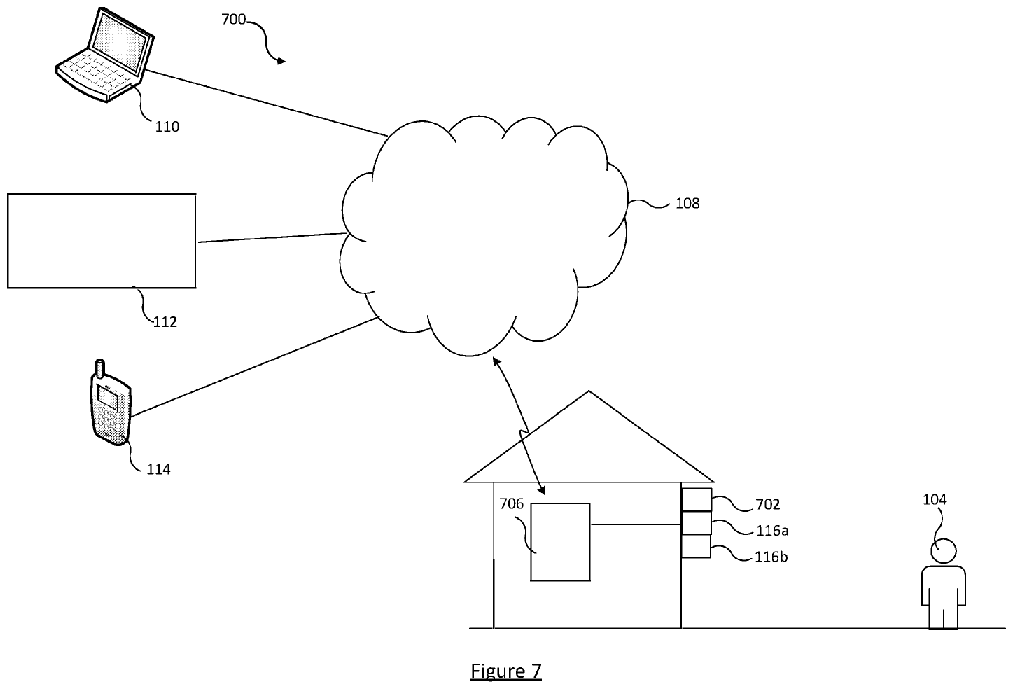

FIG. 7 illustrates a system 700 comprising a hub device 706 for determining a type of deterrent to output in response to detection of an object in an environment. The hub device 706 may be the same device as the hub device 106 of FIG. 3. The system 700 is similar to those described above and may or may not operate in a similar manner to escalate a deterrent output. Like reference numerals will therefore be used for like components.

As above, the environment shown is a home and adjacent garden. However, in other embodiments the environment may be or comprise, for example, an outdoor space (e.g. car park) associated with a residential or commercial property, or a public space (e.g. park or train station). In some embodiments, the environment may be or comprise an indoor space such as a room of a home, a shop floor, a public building or other enclosed space.

In the embodiment of FIG. 7, a single sensor 702, which may be the same as any one of the sensors 102a and 102b described above (e.g. which may take the form of a PIR motion sensor or active reflected wave sensor) is mounted to an exterior wall of the home and is arranged to monitor an outside space in which a target object (e.g. a person 104) may be present. In other embodiments, further sensors may be mounted to the exterior or interior wall of the home and arranged to monitor an outside or inside space in which a target object (e.g. a person 104) may be present. In other embodiments, the sensor 702 may monitor an interior space, for example by being mounted to an interior wall.

As shown in FIG. 7, the sensor 702 is coupled to the hub device 706 by way of a wired and/or wireless connection. Preferably, the sensor 702 is coupled wirelessly to the hub device 706 which, in this embodiment, serves as a control hub, and which may be in the form of a control panel.

The hub device 706 is configured to transmit data to the remote monitoring station 110 over the network 108. An operator at the remote monitoring station 110 responds as needed to incoming notifications which may be triggered by the sensor 702 and may also respond to incoming notifications triggered by other similar devices which monitor other environments. In other embodiments, the sensor 702 may transmit data to the remote monitoring station 110 without interfacing with the hub device 706. In both examples, the data from the sensor 702 may be sent (from the sensor 702 or hub device 706) directly to the remote monitoring station 110 or via a remote server 112. The remote monitoring station 110 may comprise for example a laptop, notebook, desktop, tablet, smartphone or the like.

Additionally or alternatively, the hub device 706 may transmit data to a remote personal computing device 114 over the network 108. A user of the remote personal computing device 114 is associated with the environment monitored by the sensor 702—for example, the user may be the homeowner of the environment being monitored, or an employee of the business whose premises are being monitored by the sensor 702. In other embodiments, the sensor 702 may transmit data to the remote personal computing device 114, server 112 and/or monitoring station 110, without interfacing with the hub device 706. In both examples the data from the sensor 702 may be sent (from the sensor 702 or hub device 706) directly to the monitoring station 110 or via the server 112. The server 112 may in any case respond to such data by sending a corresponding message to the monitoring station 110 and/or the remote person computing device 114. The remote personal computing device 114 may be for example a laptop, notebook, desktop, tablet, smartphone or the like.

The network 108 may be any suitable network, which has the ability to provide a communication channel between the sensor 702 and/or the hub device 706 to the remote devices 110, 112, 114.

In addition, the system 700 comprises a first output device 116a and a second output device 116b. In this embodiment, the first output device 116a and the second output device 116b are collocated with the sensor 702 on the exterior wall of the home. The output devices 116a. 116b are coupled to the hub device 706 by way of a wired and/or wireless connection. Preferably, the output devices 116a, 116b are coupled wirelessly to the hub device 706. In some embodiments, the output devices 116a, 116b and the sensor 702 share a common interface for communication with the hub device 706. In other embodiments, the output devices 116a, 116b may be located remotely from the sensor 702.

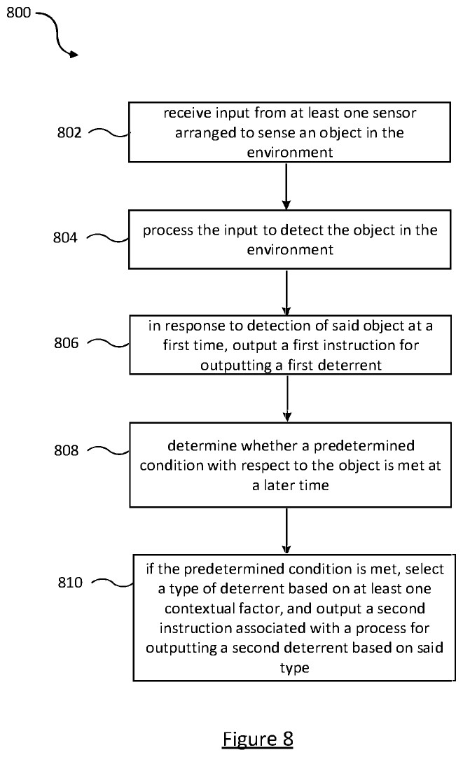

General operation of the hub device 706 is outlined in the flow diagram 800 of FIG. 8. In this case, the hub device 706 is configured for determining a type of deterrent to output and comprises a processor configured to receive input from at least one sensor arranged to sense an object in the environment, in a step 802. A step 804 is performed to process the input to detect the object in the environment. In response to detection of said object at a first time, step 806 is performed to output a first instruction for outputting a first deterrent. Next, a step 808 is performed to determine whether a predetermined condition with respect to the object is met at a later time. If the predetermined condition is met, a step 810 is performed to select a type of deterrent based on at least one contextual factor, and output a second instruction associated with a process for outputting a second deterrent based on said type.

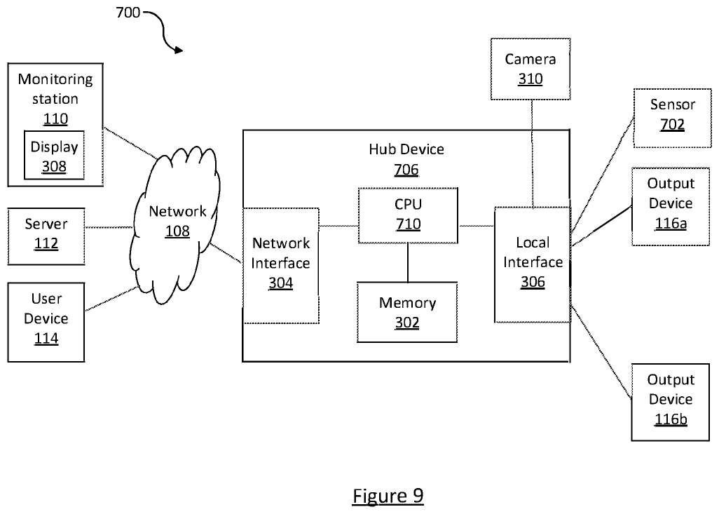

Further details of operation of the system 700 will be described below with reference to FIG. 9, which shows a schematic diagram of the system 700. As per the system of FIG. 3 above, the hub device 706 comprises a processor in the form of a central processing unit (CPU) 710 connected to a memory 302, a network interface 304 and a local interface 306.

The functionality (e.g. software) of the CPU 710 is different to that described in relation to FIG. 3 although the hardware of the system 700 may be similar to the hardware of the system 100. Thus, the CPU 710 may have the same hardware characteristics, features and structure as the CPU 300, but the processing systems may be configured differently (e.g. with different code, or in the case of an ASIC chip with different ASIC design) in order to perform the method 800 instead of the method 200.

FIG. 9 shows the CPU 710 being connected through the local interface 306 to the sensor 702 and a camera 310. While in the illustrated embodiment the sensor 702 and camera 310 are separate from the CPU 710, in other embodiments, one or more processing aspects of the sensor 702 and/or camera 310 may be provided by a processor that also provides the CPU 710, and resources of the processor may be shared to provide the functions of the CPU 710 and the processing aspects of the sensor 702 and/or camera 310. Similarly, functions of the CPU 710, such as those described herein, may be performed in the sensor 702 and/or the camera 310.

It will be appreciated from the below that in some embodiments, more than one sensor 702 may be provided. One or more of the sensors may be an active reflected wave detector. In embodiments where one of the sensors is a motion sensor and one of the sensors is an active reflected wave detector, the active reflected wave detector may consume more power in an activated state (i.e. when turned on and operational) than the motion sensor does when in an activated state. In some embodiments, three or more sensors may be provided, for example, one in each room of a building.

It will be appreciated from the below that in some embodiments, the camera 310 may not be present.

As also shown in FIG. 9 the CPU 710 is connected through the local interface 306 to a first output device 116a and a second output device 116b. It will be appreciated from the below that in some embodiments, the second output device 116b may not be present. In other embodiments, three or more output devices may be provided, for example, distributed around and/or within a building in the environment being monitored.

FIG. 9 also shows the CPU 710 being connected through the network interface 304 to the network 108, where it is then connected separately to the monitoring station 110, the remote server 112 and the remote personal computing device in the form of a user device 114. Thus, the network interface 304 may be used for communication of data to and from the hub device 706.

The local interface 306 and the network interface 304 may operate as described above. A housing may be provided around any one or more of the hub device 706, the sensor 702, the first output device 116a, the second output device 116b and the camera 310. Accordingly, any of these components may be provided together or separately. Separate components may be coupled to the CPU 710 by way of a wired or wireless connection. Further, the outputs of the sensor 702 and/or the camera 310 may be wirelessly received from/via an intermediary device that relays, manipulates and/or in part produces their outputs.

In some embodiments, the CPU 710 is configured to detect motion in the environment based on an input received from the sensor 702. The sensor 702 may take the form of any of: a motion sensor (e.g. a passive infrared (PIR) sensor), an active reflected wave sensor (e.g. a radar that detects motion based on the Doppler effect), a thermal sensor, a magnetic sensor, a proximity sensor, a threshold sensor, a door sensor and a window sensor. Notably, other sensors may also be provided to monitor further locations in the environment, although only one sensor will be described here for simplicity.

An active reflected wave detector may operate in accordance with one of various reflected wave technologies. In operation, the CPU 710 may use the input from the active reflected wave detector to determine the presence (i.e. location) and/or direction of travel of a target object 104 (e.g. human).

Preferably, the active reflected wave detector is a radar sensor, which may operate in any of the ways described above.

In some embodiments, the CPU 710 is configured to control the camera 310 to capture at least one image (represented by image data) of the environment, as described above.

The system 700 comprises a first output device 116a and a second output device 116b, each configured for outputting deterrents to an intruder in the environment. For example, the first and/or second output device 116a, b may comprise a visual output device in the form of a lighting device as described above.

Additionally or alternatively, the first and/or second output device 116a, b may comprise an audible output device in the form of a speaker for emitting audio as described above. Additionally or alternatively, the first and/or second output device 116a, b may comprise a device for emitting one or more of: tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent. Ideally, the second output device 116b is triggered after the first put device 116a and comprises a deterrent having a more severe effect on an intruder than the first deterrent.

In the present embodiment, the first output device 116a comprises both a lighting device and a speaker and the second output device 116b comprises a device for emitting visible-light obscuring matter. In the present example, the sensor 702 is a motion sensor but in other embodiments the sensor 702 may be an active reflected wave detector.

In an example operation, the CPU 710 processes the input from the sensor 702 to detect the object 104 in the environment. In response to detection of the object 104 at a first time, the CPU 702 outputs a first instruction to the first output device 116a for outputting a first deterrent.

In this case, the first deterrent comprises light and sound.

The CPU 710 then determines whether a predetermined condition with respect to the object 104 is met at a later time—for example, a predefined amount of time, which may be seconds after the first time. The predetermined condition may be that the object is still being detected by the sensor 702; that the object is in a particular one of a set of locations (e.g. as determined as the region monitored by a particular sensor 702 or as identified in a specific region in a field of view of a single sensor such as a ranging active reflected wave detector); that the object is moving in a predefined direction, or at a predefined speed (e.g. based on input from an active reflected wave detector over time that may be used to track the object and/or identify its respective positions at different times, or based on input from two or more motion sensors monitoring different locations separated by a known distance).

If the predetermined condition is met, the CPU 710 selects a type of deterrent to output next, based on at least one contextual factor by referring to a look-up table stored in the memory 302. The look-up table may contain a list correlating one or more contextual factors with one or more possible deterrents. The contextual factors may comprise information on the type of environment being monitored (e.g. commercial, residential, valuable goods store, jewellery store, bank). In some embodiments the contextual factor may comprise time-based information (e.g. if night-time a more severe deterrent may be selected than if an intruder is detected during daytime). In some embodiments, the contextual factor may comprise information about the whereabouts of one or more persons (e.g. residents) associated with the environment. For example, the CPU 710 may determine, from data logged by the sensor 702, whether a resident is at home and may select a more severe deterrent if there is deemed to be an imminent threat to the resident.

The type of deterrent selected may be a specific deterrent (e.g. smoke) or a set of available deterrents that may be suitable in light of the context (e.g. audio, visual or light-obscuring material).

The CPU 710 then outputs a second instruction associated with a process for outputting a second deterrent from the second output device 116b, based on said type. The second deterrent may be more severe than the first deterrent and may comprise something other than an audio or visual deterrent. For example, if the premises is a jewellery store and the intruder is detected at night-time, the look-up table may indicate that the type of deterrent output should be severe (e.g. visible-light obscuring and/or physiologically affecting matter). However, if the premises is a home and no-one is currently in the environment apart from the intruder, a less severe type of deterrent may be selected as the second deterrent such as an alarm or flashing light.

The second instruction may be relayed to the monitoring station 110 and a user prompted to confirm that the selected type of deterrent should be output. Where the type of deterrent includes a list of suitable deterrents, the user may further select a particular deterrent from the list. This information is communicated to the CPU 710 and the appropriate output device 116a. 116b triggered to output the chosen deterrent.

In a particular embodiment, two motion sensors 702 may be located in different areas of a home. For example, a first motion sensor may be configured to sense motion near a door or entry point and a second motion sensor may be configured to detect motion on a stairway leading to bedrooms. The predetermined condition may be that the second motion sensor detects movement within a predetermined period (e.g. 10 seconds) after the first motion sensor detects movement. In which case, it is inferred than an intruder has entered the home and is moving up the stairs towards the bedrooms.

The first deterrent (e.g. an alarm) may be output in response to the detection by the first motion sensor. If it is then determined that the predetermined condition is met by the second motion sensor detecting the intruder within the predetermined period after the detection by the first sensor, the CPU 710 selects a type of deterrent to output as the second deterrent, based on at least one contextual factor. In this case, the contextual factor may be based on whether the system is set to fully armed (i.e. occupants away and no-one is home) or partially armed (i.e. only the ground floor and stairway is armed as the occupants are asleep upstairs); and may also be based on a time of day, for example. The CPU 710 will therefore check the system status and consult the memory 302 to determine a type of deterrent to output as the second deterrent based on each system status. For example, if the system is fully armed, the type of deterrent may be selected from any available deterrents. These may include a selection of any of the following that may be available via the output device 1016: light, sound, visible-light obscuring matter (e.g. smoke or fog), tear gas, fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent. If the system is only partially armed (i.e. the occupants are upstairs), the type of second deterrent may be selected from only the most severe deterrents that are available due the need to take urgent and decisive action to protect the occupants. Thus, the type of second deterrent may be selected from a list including deterrents other than light or sound (e.g. visible-light obscuring matter, tear gas, fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent. Similarly, the time of day may be determinative of what deterrents are in the list. For example, late into the night it may be assumed that the occupants are asleep.

In some embodiments, only a subset of one or more of the deterrents listed may be available via each output device 1016. If there is a choice of possible deterrents, the CPU 710 may be configured to select a particular one of the available deterrents to output or the CPU 710 may relay the list of possible deterrents to the monitoring station for an operator to select the deterrent to output as explained above.

In other embodiments, the contextual factor may be based on whether an occupant or resident has been detected somewhere in the environment at a time before the intruder is detected. For example, an occupant may be detected by a motion sensor in a particular room of a house prior to a first sensor sensing an intruder at an access point to the house (e.g. door). If a second sensor subsequently senses that the intruder is moving towards the room where the occupant was last detected, the CPU 710 may consult the memory 302 to determine a type of deterrent to output as the second deterrent when the intruder appears to be moving in the direction of the occupant. More specifically, the CPU 710 will consult the memory 302 to determine where the occupant was last detected and will determine if the location or direction of motion of the intruder is towards the occupant's location based on sensor input. The closer the intruder comes to the location of the occupant a more severe type of deterrent may be selected for output. For example, the first deterrent may be of an audio type and a second deterrent may be of a physical type (e.g. light-obscuring material or tear gas). Thus an intruder's proximity to a potential occupant may be a relevant contextual factor.

Other indicators of the threat level, based on a measured parameter, may additionally or alternatively be used as contextual factors. For example, other contextual factors may include one or more of:
a) a measured behavioral response of the person to an already outputted deterrent—for example, a detected erratic motion, as may be measured by an active reflected wave detector, may indicate potential for aggressive or unpredictable behavior;
b) whether a weapon is detected on the person—for example, using image recognition on a captured image, or based on a signal received from active reflected wave detector (e.g. in accordance with International patent application PCT/IL2020/050408, the contents of which are incorporated in their entirety, by reference);
c) a measured physiological parameter of the intruder such as a heart rate and/or a breathing rate—for example, using an active reflected wave sensor, wherein the parameter may optionally be used to assess a stress level of the intruder, whereby being above a certain stress level or increase in stress level may indicate a greater threat to a potential occupant;
d) an intruder's measured speed of approaching a potential occupant—for example using an active reflected wave sensor or a passive infrared motion sensor, whereby fast approaches may be indicative an imminence of a threat or aggressive intent; or
c) a gait of a detected person—e.g. a drunken gait, which may be measured by an active reflected wave detector, may indicate potential for dangerous/threatening behavior.

In some of these examples, an active reflected wave sensor is more specifically a radar. One or more of the contextual factors (a) to (d) may be compared with a threshold. The comparison with the threshold may be used to determine a risk level to a potential occupant posed by the intruder, or to estimate a likelihood that the intruder may sufficiently ignore a mere alarm siren. For example, a drunken, weapon wielding, stressed and/or rapidly moving intruder may be indicative of an increased threat, warranting a strong deterrent.

In yet another example, a contextual factor may be an identity of the intruder. For example, an identity may be determined by facial recognition and matched against a database to determine whether a threat level is associated with the intruder, e.g. based on a criminal history.

In other embodiments, other contextual factors may be used to determine the type of second deterrent to output. For example, if the premises is a high value goods store (e.g. a jewellery store) and an intruder is detected, the second deterrent may be selected from a first deterrent type (e.g. audio and/or light-obscuring matter). However, if the premises is an office and an intruder is detected outside of daylight hours, the second deterrent may be selected from a second deterrent type (e.g. light and/or light-obscuring matter). Again, other contextual factors may be taken into account, e.g. time of day, or location, and/or ability to be serviced by security personnel or a grade of such servicing. For example, for remote locations that would take a long time to be reached by a security guard a higher priority may be placed on more severe deterrents.

Yet other examples of contextual factors may be whether the premises is commercial or residential, and/or an age and/or mobility of the resident(s).

Some or all aspects of the embodiment described above in relation to FIGS. 7 to 9 may be incorporated into aspects of the embodiments described above in relation to FIGS. 1 to 6. In some embodiments, the CPU 710 may be provided in the server 112 or monitoring station 110 and there may be no hub device 706. In which case, the sensor 702 and/or output devices 116a, 116b (which optionally may be integrated into one device) may communicate directly with the server 112 or monitoring station 110 (e.g. via a cellular network).

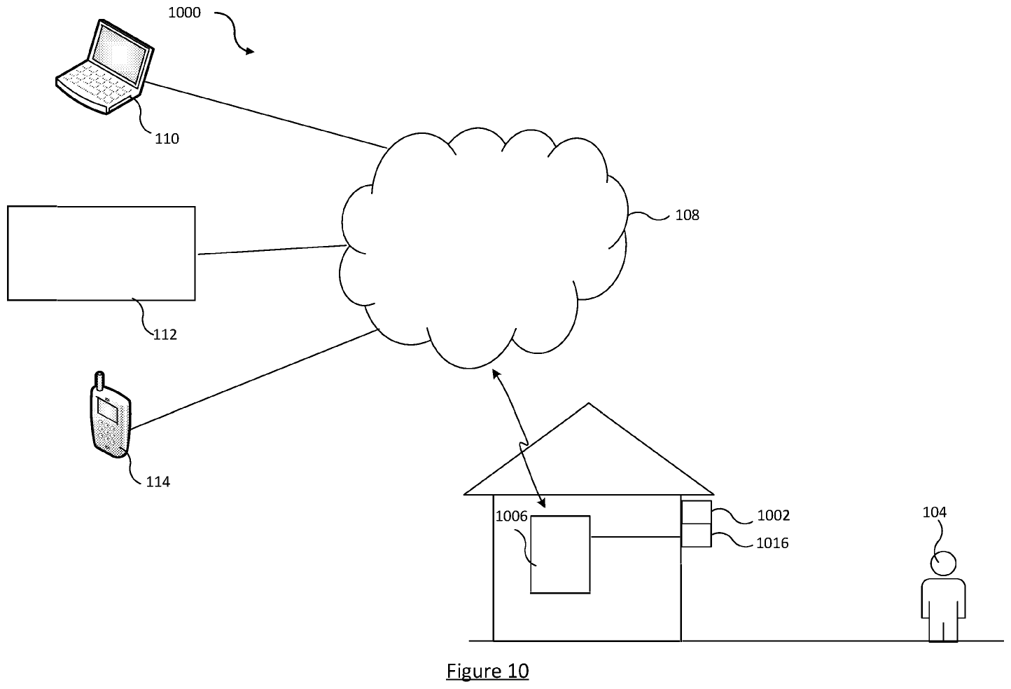

FIG. 10 illustrates a system 1000 comprising a hub device 1006 for enabling output of a deterrent in response to detection of an object in an environment. The hub device 1006 may be the same device as the hub device 106 of FIG. 3. The system 1000 is similar to those described above and may or not operate in a similar manner to escalate a deterrent output. Like reference numerals will therefore be used for like components.

As above, the environment shown is a home and adjacent garden. However, in other embodiments the environment may be or comprise, for example, an outdoor space (e.g. car park) associated with a residential or commercial property, or a public space (e.g. park or train station). In some embodiments, the environment may be or comprise an indoor space such as a room of a home, a shop floor, a public building or other enclosed space.

In the embodiment of FIG. 10, a single sensor 1002, which may be the same as any one of the sensors 102a and 102b described above (e.g. which may take the form of a PIR motion sensor or active reflected wave sensor) is mounted to an exterior wall of the home and is arranged to monitor an outside space in which a target object (e.g. a person 104) may be present. In other embodiments, further sensors may be mounted to the exterior or interior wall of the home and arranged to monitor an outside or inside space in which a target object (e.g. a person 104) may be present.

As shown in FIG. 10, the sensor 1002 is coupled to the hub device 1006 by way of a wired and/or wireless connection. Preferably, the sensor 1002 is coupled wirelessly to the hub device 1006 which, in this embodiment, serves as a control hub, and which may be in the form of a control panel.

The hub device 1006 is configured to transmit data to the remote monitoring station 110 over the network 108. An operator at the remote monitoring station 110 responds as needed to incoming notifications which may be triggered by the sensor 1002 and may also respond to incoming notifications triggered by other similar devices which monitor other environments. In other embodiments, the sensor 1002 may transmit data to the remote monitoring station 110 without interfacing with the hub device 1006. In both examples, the data from the sensor 1002 may be sent (from the sensor 1002 or hub device 1006) directly to the remote monitoring station 110 or via a remote server 112. The remote monitoring station 110 may comprise for example a laptop, notebook, desktop, tablet, smartphone or the like.

Additionally or alternatively, the hub device 1006 may transmit data to a remote personal computing device 114 over the network 108. A user of the remote personal computing device 114 is associated with the environment monitored by the sensor 1002—for example, the user may be the homeowner of the environment being monitored, or an employee of the business whose premises are being monitored by the sensor 1002. In other embodiments, the sensor 1002 may transmit data to the remote personal computing device 114 without interfacing with the hub device 1006. In both examples the data from the sensor 1002 may be sent (from the sensor 1002 or hub device 1006) directly to the remote personal computing device 114 or via the server 112.

The remote personal computing device 114 may be for example a laptop, notebook, desktop, tablet, smartphone or the like.

The network 108 may be any suitable network, which has the ability to provide a communication channel between the sensor 1002 and/or the hub device 1006 to the remote devices 110, 112, 114.

In addition, the system 1000 comprises an output device 1016, which may be the same as any one of the output devices 116a and 116b described above. In this embodiment, the output device 1016 is collocated with the sensor 1002 on the exterior wall of the home. The output device 1016 is coupled to the hub device 1006 by way of a wired and/or wireless connection. Preferably, the output device 1016 is coupled wirelessly to the hub device 1006. In some embodiments, the output device 1016 and the sensor 1002 share a common interface for communication with the hub device 1006. In other embodiments, the output device 1016 may be located remotely from the sensor 1002. In some embodiments, more than one output device 1016 may be provided and each may be distributed around the environment.

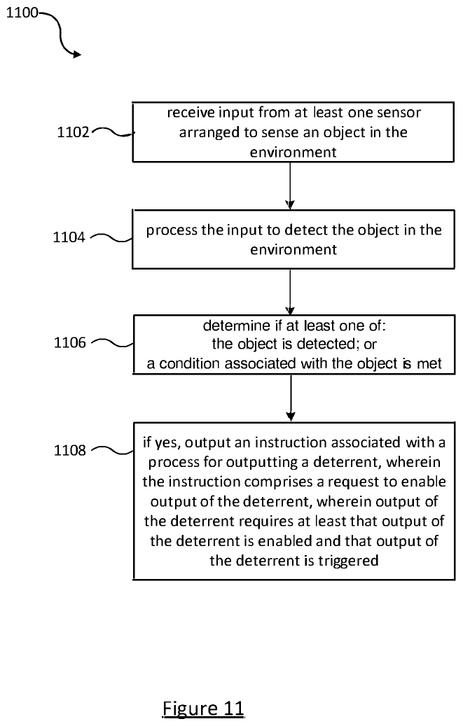

General operation of the hub device 1006 is outlined in the flow diagram 1100 of FIG. 11. In this case, the hub device 1006 is configured for enabling output of a deterrent and comprises a processor configured to receive input from at least one sensor arranged to sense an object in the environment, in a step 1102. A step 1104 is performed to process the input to detect the object in the environment. Next, there is a step 1106 of determining if at least one of: the object is detected; and a condition associated with the object is met. If the determination is positive, a step 1108 is performed to output an instruction associated with a process for outputting a deterrent, wherein the instruction comprises a request to enable output of the deterrent, wherein output of the deterrent requires at least that output of the deterrent is enabled and that output of the deterrent is triggered.

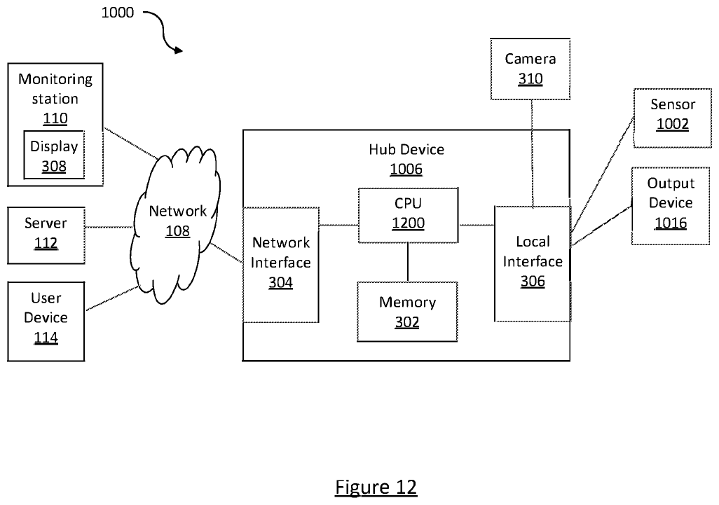

Further details of operation of the system 1000 will be described below with reference to FIG. 12, which shows a schematic diagram of the system 1000. As per the system of FIG. 3 above, the hub device 1006 comprises a processor in the form of a central processing unit (CPU) 1200 connected to a memory 302, a network interface 304 and a local interface 306.

The functionality (e.g. software) of the CPU 1200 is different to that described in relation to FIG. 3 although the hardware of the system 700 may be similar to the hardware of the system 100. Thus, the CPU 1200 may have the same hardware characteristics, features and structure as the CPU 300, but the processing systems may be configured differently (e.g. with different code, or in the case of an ASIC chip with different ASIC design) in order to perform the method 1100 instead of the method 200.

FIG. 12 shows the CPU 1200 being connected through the local interface 306 to the sensor 1002 and a camera 310. While in the illustrated embodiment the sensor 1002 and camera 310 are separate from the CPU 1200, in other embodiments, one or more processing aspects of the sensor 1002 and/or camera 310 may be provided by a processor that also provides the CPU 1200, and resources of the processor may be shared to provide the functions of the CPU 1200 and the processing aspects of the sensor 1002 and/or camera 310. Similarly, functions of the CPU 1200, such as those described herein, may be performed in the sensor 1002 and/or the camera 310.

It will be appreciated from the below that in some embodiments, more than one sensor 1002 may be provided. One or more of the sensors may be an active reflected wave detector. In embodiments where one of the sensors is a motion sensor and one of the sensors is an active reflected wave detector, the active reflected wave detector may consume more power in an activated state (i.e. when turned on and operational) than the motion sensor does when in an activated state. In some embodiments, three or more sensors may be provided, for example, one in each room of a building.

It will be appreciated from the below that in some embodiments, the camera 310 may not be present.

As also shown in FIG. 12 the CPU 1200 is connected through the local interface 306 to an output device 1016. In other embodiments, two or more output devices may be provided, for example, distributed around and/or within a building in the environment being monitored.

FIG. 12 also shows the CPU 1200 being connected through the network interface 304 to the network 108, where it is then connected separately to the monitoring station 110, the remote server 112 and the remote personal computing device in the form of a user device 114. Thus, the network interface 304 may be used for communication of data to and from the hub device 1006.

The local interface 306 and the network interface 304 may operate as described above. A housing may be provided around any one or more of the hub device 1006, the sensor 1002, the output device 1016 and the camera 310. Accordingly, any of these components may be provided together or separately. Separate components may be coupled to the CPU 1200 by way of a wired or wireless connection. Further, the outputs of the sensor 1002 and/or the camera 310 may be wirelessly received from/via an intermediary device that relays, manipulates and/or in part produces their outputs.

In some embodiments, the CPU 1200 is configured to detect motion in the environment based on an input received from the sensor 1002. The sensor 1002 may take the form of any of: a motion sensor (e.g. a passive infrared (PIR) sensor), an active reflected wave sensor (e.g. a radar that detects motion based on the Doppler effect), a thermal sensor, a magnetic sensor, a proximity sensor, a threshold sensor, a door sensor and a window sensor. Notably, other sensors may also be provided to monitor further locations in the environment, although only one sensor will be described here for simplicity.

An active reflected wave detector may operate in accordance with one of various reflected wave technologies. In operation, the CPU 1200 may use the input from the active reflected wave detector to determine the presence (i.e. location) and/or direction of travel of a target object 104 (e.g. human) as described above.

Preferably, the active reflected wave detector is a radar sensor, which may operate in any of the ways described above.

In some embodiments, the CPU 1200 is configured to control the camera 310 to capture at least one image (represented by image data) of the environment, as described above.

The system 1000 comprises an output device 1016 configured for outputting one or more deterrents to an intruder in the environment. For example, the output device 1016 may comprise a visual output device in the form of a lighting device such as described above.

Additionally or alternatively, the output device 1016 may comprise an audible output device in the form of a speaker for emitting audio as described above.

Additionally or alternatively, the output device 1016 may comprise a device for emitting one or more of: tear gas, visible-light obscuring matter (e.g. smoke or fog), fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent.

In the present embodiment, the output device 1016 comprises a lighting device and a device for emitting visible-light obscuring matter in the form of smoke. In the present example, the sensor 1002 is a motion sensor but in other embodiments the sensor 1002 may be an active reflected wave detector.

In an example operation, the CPU 1200 processes the input from the sensor 1002 to detect the object 104 in the environment. The CPU 1200 may act purely on the basis that an object has been detected or may check whether a predetermined condition with respect to the object is met before taking further action. The predetermined condition may be, for example, that the object is in a particular one of a set of locations; that the object is moving in a predefined direction, or at a predefined speed.

If the predetermined condition is met, the CPU 1200 then outputs an instruction associated with a process for outputting a deterrent from the output device 1016, wherein the instruction comprises a request to enable output of the deterrent and wherein output of the deterrent requires at least that output of the deterrent is enabled and that output of the deterrent is triggered. The requirement to have the output enabled mitigates against the possibility of accidentally triggering the outputting of the deterrent, which is particularly important for strong deterrents, such as any of the second deterrents described herein, for example.

In this embodiment, the request to enable output of the deterrent comprises controlling an electrical circuit that is independent of an electrical circuit used to trigger the deterrent. More specifically, the outputting of the deterrent requires both the trigger and the enablement, each of which is controlled independently of the other.

In some embodiments, the request to enable output of the deterrent is relayed to the output device 1016 and the output device 1016 is enabled by performance of a safety check or other diagnostic check. For example, the output device 1016 may be checked to ensure an output nozzle for the visible-light obscuring matter (e.g. smoke) is able to be opened to release the visible-light obscuring matter (e.g. smoke) when triggered.

The instruction is also relayed to the monitoring station 110 and a user prompted to confirm that the deterrent should be output. For example, the monitoring station 110 may be instructed to display on a display screen a request for confirmation to proceed with the output of a specific deterrent (e.g. a light-obscuring material). In other embodiments, the monitoring station 110 may be instructed to display on a display screen a request for selection of a specific deterrent from a list of possible deterrent options. In some embodiments, the monitoring station 110 may be provided with one or more images from a camera so that the user may verify whether an intruder has been detected before confirming that the deterrent should be output. The user confirmation may be provided in the form of a user input to a device at the monitoring station 110. The confirmation is then communicated to the CPU 1200, for example, via cellular communication network, and the output device 1016 triggered to output the deterrent. As the output device 1016 is already enabled at this time, there is no further delay and the deterrent is output. This is important because, in the case of a security device, prompt action is required to prevent unauthorised entry, minimise damage and reduce the risk of theft or injury. However, if the output device 1016 was not enabled or if it was prevented from being enabled, the triggering of the output device 1016 would not cause the outputting of the deterrent. In which case, an error message may be relayed to the CPU 1200 to report that the deterrent was not output. This message may additionally or alternatively be relayed to the monitoring station 110. Further this may be used to inform a person at the monitoring station wanting to output the deterrent that the enabling has been successful before the person acts to transmit the triggering signal to the output device 1016.

In some embodiments, the process may comprise issuing a challenge to a user device (which may be at the monitoring station 110); verifying a challenge response from the user device; and only transmitting the trigger to output the deterrent if the user response is to proceed and the challenge response is verified. More specifically, the CPU 1200 may issue a challenge to a user device at the monitoring station 110. The challenge may be relayed along with a message that tells the user device that an event has happened (i.e. an intruder detected) and/or provides a recommended deterrent type. If the user instructs or confirms via user input to the user device, that the deterrent should be output, the confirmation is communicated from the monitoring station 110 to the CPU 1200, or directly to the output device 1016, along with a challenge response from the user device. The challenge may be based on a time-stamp, which optionally may be encrypted (e.g. using a public key of the monitoring station), wherein the challenge response may require the encrypted time-stamp to be decrypted by the monitoring station 110 (e.g. using a private key of the monitoring station); and/or the challenge response may require the time stamp to be signed using a private key of the monitoring station, which can then be verified using a public key of the monitoring station. Once received, the CPU 1200 will verify whether the challenge response is as expected and, if so, and the user has confirmed output of the deterrent, the CPU 1200 will proceed to trigger the output device 1016 to output the deterrent. This ensures that the instruction to proceed is actually received from the monitoring station 110/user device and not a rogue device carrying out a so-called “replay attack” which mirrors a previous user confirmation from the monitoring station. The rogue device will therefore not relay the correct challenge response since the rogue device will not be able provide a challenge response that is based on the provided time-stamp.

In other embodiments, the challenge may be based on a counter value or random number instead of a time-stamp.

In any case, the challenge response may require the user device to perform a pre-defined function on the unique counter value or random number and to return a resulting value to the CPU 1200 for verification. The predefined function may for example be a secret hashing function known to both (i) the user device/monitoring station and (ii) the hub device 1006 and/or output device 1016. As the counter value or random number are unlikely to be repeated, it will not be possible for the rogue device to easily determine the correct challenge response in order to carry out a successful replay attack.

As will be appreciated, any other challenges known to the person skilled in the art may be employed.

Aspects of the embodiment described above in relation to FIGS. 10 to 12 may be incorporated into aspects of the embodiments described above in relation to FIGS. 1 to 9. For example, the condition may be determined with respect to one or more of: a location; a direction of travel or a speed of travel of the object. Additionally or alternatively, the processor may be configured to select a type of deterrent based on at least one contextual factor such that the deterrent is based on said type.

The present aspect of the invention, which requires a trigger and independent enablement for output of a deterrent is not limited to embodiments in which there is a first (relatively mild) deterrent followed by a second (more severe) deterrent. As such, the process described with reference to FIG. 11 may be implemented even if there is no prior deterrent.

In some embodiments, the CPU 1200 may be provided in the server 112 or monitoring station 110 and there may be no hub device 1006. In which case, the sensor 1002 and/or output device 1016 (which optionally may be integrated into one device) may communicate directly with the server 112 or monitoring station 110 (e.g. via a cellular network).

As will be appreciated the term “CPU” as used herein may be replaced herein with “one or more processors”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Furthermore, features described in relation to one embodiment may be mixed and matched with features from one or more other embodiments, within the scope of the claims.

1-59. (canceled)

60. A device for determining a type of deterrent to output by a security system in response to detection of an object in an environment, the device comprising:
a processor configured to:
receive input from at least one sensor arranged to sense an object in the environment;
process the input to detect the object in the environment;
in response to detection of said object at a first time, output a first instruction for outputting a first deterrent;
determine whether a predetermined condition with respect to the object is met at a later time; and
if the predetermined condition is met, select a type of deterrent based on at least one contextual factor, and output a second instruction associated with a process for outputting a second deterrent based on said type;
wherein the contextual factor is based on whether the security system is set to fully armed or partially armed.

61. The device of claim 60 wherein the type of deterrent is associated with a list of available deterrents, from which a user further selects the second deterrent; or
wherein the type of deterrent is associated with a subset of a list of available deterrents, from which a user further selects the second deterrent; or
wherein the type of deterrent is associated with a specific deterrent; or
wherein the type of deterrent is associated with a specific combination of deterrents for outputting.

62-64. (canceled)

65. The device of claim 60 wherein the type of deterrent is associated with one or more deterrents from a list comprising: light, audio, tear gas, visible-light obscuring matter, fluid, paralyzing substance, pepper spray, sneeze inducing spray, a high output sound pressure, an electrically conductive projectile, a stink bomb, intermittent light, a physical deterrent, a physiologically affecting deterrent, or a psychologically affecting deterrent.

66. The device of claim 60 wherein the at least one contextual factor comprises information about the whereabouts of one or more persons associated with the environment that are not said object; optionally, wherein the information about the whereabouts has been inferred from data obtained from the at least one sensor; and/or wherein the information about the whereabouts comprises whether one or more persons are in the environment.

67. (canceled)

68. (canceled)

69. The device of claim 60 wherein the at least one contextual factor comprises information obtained from a look-up table, wherein the information obtained from the look-up table comprises information on a type of the environment, and optionally, wherein the type of the environment comprises one or more of commercial, residential, valuable goods store, jewellery store, or bank.

70. (canceled)

71. (canceled)

72. The device of claim 60 wherein the at least one contextual factor comprises time-based information.

73. The device of claim 72 wherein the time-based information comprises whether the later time is at night-time or wherein the time-based information comprises whether the later time is during a time window associated with a normal operational practice in the environment.

74. (canceled)

75. The device of claim 60 wherein the predetermined condition is determined with respect to one or more of: a location or a direction of travel of the object at the later time.

76. The device of claim 60 wherein the predetermined condition is determined based on a speed of the object; wherein the speed of the object is determined by how soon after a known event the object is detected at a specified location.

77. (canceled)

78. (canceled)

79. The device of claim 60 wherein the process for outputting the second deterrent comprises: prompting a user for confirmation to begin outputting the second deterrent; enabling outputting of the second deterrent.

80. (canceled)

81. The device of claim 60 wherein the selection of the type of deterrent is based on a risk of damage; a risk of affecting a person other than an intruder.

82. (canceled)

83. The device of claim 60 wherein the contextual factor comprises one or more of:
a) a measured behavioral response to an already outputted deterrent;
b) whether a weapon is detected;
c) a measured physiological parameter;
d) a measured speed of approach of the object to a potential occupant;
e) a gait of a detected person; or
f) an identity of the object.

84. (canceled)

85. A computer implemented method for determining a type of deterrent to output by a security system in response to detection of an object in an environment, the method comprising:
receiving input from at least one sensor arranged to sense an object in the environment;
processing the input to detect the object in the environment;
in response to detection of said object at a first time, outputting a first instruction for outputting a first deterrent;
determining whether a predetermined condition with respect to the object is met at a later time; and
if the predetermined condition is met, selecting a type of deterrent based on at least one contextual factor, and outputting a second instruction associated with a process for outputting a second deterrent based on said type;
wherein the contextual factor is based on whether the security system is set to fully armed or partially armed.

86. A non-transitory computer-readable storage medium comprising instructions which, when executed by a processor cause the processor to perform the method of claim 85.

87. A system for determining a type of deterrent to output by a security system in response to detection of an object in an environment, the system comprising:
at least one sensor arranged to sense an object in the environment;
at least one output device; and
at least one processor, wherein the at least one processor is configured to perform steps of:
receiving input from the at least one sensor;
processing the input to detect the object in the environment;
in response to detection of said object at a first time, outputting a first instruction for outputting a first deterrent;
determining whether a predetermined condition with respect to the object is met at a later time; and
if the predetermined condition is met, selecting a type of deterrent based on at least one contextual factor, and outputting a second instruction associated with a process for outputting a second deterrent based on said type;
wherein the contextual factor is based on whether the security system is set to fully armed or partially armed.

88-125. (canceled)
